(19) United States
(12) Patent Application Publication
(10) Pub. No.: US 2022/0082405 A1
(43) Pub. Date: Mar. 17, 2022

(54) SYSTEM AND METHOD FOR VEHICLE EVENT DATA PROCESSING FOR IDENTIFYING PARKING AREAS

(71) Applicant: Wejo Ltd., Manchester (GB)

(72) Inventors: Dylan Sumner, Manchester (GB); Tom Dobrzycki, Cheshire (GB); Maxime Drilhon, Manchester (GB); Paul Burgoine, Manchester (GB)

(73) Assignee: Wejo Ltd., Manchester (GB)

(21) Appl. No.: 17/215,902

(22) Filed: Mar. 29, 2021

Related U.S. Application Data
(60) Provisional application No. 63/000,928, filed on Mar. 27, 2020.

(51) Int. Cl. G01C 21/36; G01C 21/34; G01C 21/00

(52) U.S. Cl. CPC G01C 21/3685; G01C 21/3682; G01C 21/3874; G01C 21/3617; G01C 21/3867; G01C 21/3446

(57) ABSTRACT

Embodiments are directed to a system and methods for processing geolocation event data points and mapping the event data to road segments. An ingestion server ingests location event data. The system then processes the location event data to identify Journeys. Journey points are clustered to identify a geoshape for a parking area.

### CROSS REFERENCE TO RELATED APPLICATIONS

The present application is related to U.S. Prov. Pat. App. 63/000,928 filed on Mar. 27, 2020.

### BACKGROUND OF THE DISCLOSURE

The automotive industry is undergoing a radical change unlike anything seen before. Disruption is happening across the whole of the mobility ecosystem. The result is vehicles that are more automated, connected, electrified and shared. This gives rise to an explosion of car generated data. This rich new data asset remains largely untapped.

Vehicle location event data, such as GPS data, is extremely voluminous and can involve 200,000-600,000 records per second. The processing of location event data presents a challenge for conventional systems to provide substantially real-time analysis of the data, especially for individual vehicles. Further, individual vehicle data faces challenges for properly anonymizing it while identifying individual vehicle data for analysis at these scales. What is needed are system platforms and data processing algorithms and processes configured to process and store high-volume data with low latency while still making the high-volume data available for analysis and re-processing.

While there are systems for tracking vehicles, what is needed is near real-time and accurate journey data from high-volume vehicle data. What is needed are systems and algorithms configured to accurately identify journeys and journey destinations from vehicle movement and route analysis.

### SUMMARY OF THE DISCLOSURE

The following briefly describes embodiments to provide a basic understanding of some aspects of the innovations described herein. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments of a system, method, and computer program product for processing vehicle event data are disclosed herein.

In an embodiment, the processor is configured to execute the instructions for the method further comprising encoding location data in the event data to a proximity.

In an embodiment, the processor is configured to execute the instructions for the method further comprising mapping the geohash to a map database.

In an embodiment, described is a system comprising: the processor being configured to execute instructions to at least: ingest vehicle event data; and process the vehicle event data at the server to identify a parking area, wherein the processing comprises:

identifying a plurality of Journeys from vehicle event data;
matching the vehicle event data to map data from a map database;
selecting Journey points from the plurality Journeys;
clustering the selected points with a clustering algorithm; and
defining a shape around the cluster of points to define a parking area.

In an embodiment, the selected Journey points are Journey start points, Journey end points, or both.

The clustering algorithm can be a density-based algorithm. The density-based algorithm can include a DBSCAN algorithm.

In an embodiment, the processor is configured to execute instructions to at least: road snap the longitude and latitude of each of the Journey points to the map database; select Journey start points and Journey end points as the Journey points; cluster the road-snapped Journey points to define a cluster of curbside points; define a convex-hull shape around the clustered points to define the parking area as a curbside parking area. In an embodiment, the processor is configured to execute instructions to at least: identify map areas unlikely to be the curbside parking areas; and filter out Journey points mapped to the areas unlikely to be the curbside parking areas.

In an embodiment, the processor is configured to execute instructions to at least: select the Journey end points as the Journey points;

access map data comprising Point of Interest (POI) data;
generate an R-Tree Index with the POI data;
query the R-Tree to identify POIs in a defined close proximity to the clustered Journey points; and define a parking area based on the shapes defined around the clustered data points close to the POIs; and label the parking lot areas with the POIs. The defined close proximity is can be from 50 meters to 200 meters, for example 100 meters. The processor can be configured to enrich a map database having identified parking lot areas that are not associated with POIs with the labeled parking lot areas. In an embodiment, the processor is configured to analyze the vehicle event data of Journeys with the Journey end points of the identified parking areas.

In an embodiment, the processor is configured to execute instructions to at least: provide a training database with the parking lots that are labelled with POI; provide the training database with identified parking lot that are not labelled with POI; generate parking lot features from vehicle event data for the Journeys with Journey end points of the identified parking areas; and train a prediction engine on the training database. The features can include one or more of a total visitors number, a number of unique visitors, an average dwell time, and a percentage of visitors in a defined time period. The prediction engine can comprise a plurality of Positive-Unlabeled Gradient Boosting models configured to output a probability score for a POI category.

In an embodiment, the system can comprise a plurality of processors configured to process the location event data for a map data set inparallel to identify a parking area, wherein the processing comprises:

obtaining the map data set;
splitting the map data set into a plurality of geohashes;
splitting each of the plurality of geohashes into road segment polygons, and
selecting the Journey endpoints for each polygon and processing each road segment polygon in parallel to at least, for each road segment polygon: cluster the selected points with a clustering algorithm; and define a shape around the cluster of points. In an embodiment, at least one of the processors is configured execute instructions to at least road snap the longitude and latitude of each of the Journey points to the map database, and select Journey start points and Journey end points as the Journey points; and the plurality of processors can be configured to execute instructions to parallel process each road segment polygon to at least: road snap the longitude and latitude of each of the Journey points to the map database; select Journey start points and Journey end points as the Journey points; cluster the road-snapped Journey points to define a cluster of curbside points; and define a convex-hull shape around the clustered points to define the parking area as a curbside parking area.

In an embodiment, at least one of the plurality of processors can be configured to select the Journey end points as the Journey points and, after parallel processing each road segment polygon, execute instructions to at least: access map data comprising Point of Interest (POI) data; generate an R-Tree Index with the POI data; query the R-Tree to identify POIs in a defined close proximity to the clustered Journey points; and define a parking area based on the shapes defined around the clustered data points close to the POIs; and label the parking lot areas with the POIs.

At least one embodiment describes a method implemented by a computer including a processor, and a memory including program memory including instructions for executing the methods described above and herein.

At least one embodiment describes a computer program product including program memory including instructions which, when executed by processor, executes the methods described above and herein.

As used herein, a Journey can include any trip, run, or travel to a destination.

An exemplary advantage of the systems and methods described herein is optimized low latency. The present disclosure is capable of ingesting and processing vehicle event data for up to 600,000 records per second for up to 12 million vehicles.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 is a system diagram of an environment in which at least one of the various embodiments can be implemented.

FIG. 2 shows a logical architecture and flowchart for an Ingress Server system in accordance with at least one of the various embodiments of the present disclosure.

FIG. 3 shows a logical architecture and flowchart for a Stream Processing Server system in accordance with at least one of the various embodiments.

FIG. 4 represents a logical architecture and flowchart for an Egress Server system in accordance with at least one of the various embodiments.

FIGS. 5A-F illustrate a logical architecture and flowchart for a process for an Analytics Server system in accordance with at least one of the various embodiments.

FIG. 6 illustrates a logical architecture and flowchart for a process for a Portal Server system in accordance with at least one of the various embodiments.

FIG. 7 is a flowchart showing a data quality pipeline of data processing checks for the system.

FIG. 8 is a flow chart and interface diagram for egressing a feed to an interface in accordance with at least one of the various embodiments.

FIG. 9 illustrates a cloud computing architecture in accordance with at least one of the various embodiments.

FIG. 10 illustrates a logical architecture for cloud computing platform in accordance with at least one of the various embodiments.

FIGS. 11A-11E shows mapping interfaces for car parks.

FIGS. 12A-12B shows mapping interfaces for car parks.

FIG. 13 shows a mapping interface for car parks.

FIGS. 14A-14B show graphs of parking distributions.

FIG. 14C shows a mapping interface for car parks.

FIG. 15 shows a mapping interface for car parks.

FIG. 16 shows a mapping interface for a car park.

### DETAILED DESCRIPTION OF THE EMBODIMENTS

Various embodiments now will be described more fully hereinafter with reference to the accompanying drawings, which form a part hereof, and which show, by way of illustration, specific embodiments by which the innovations described herein can be practiced. The embodiments can, however, be embodied in many different forms and should not be construed as limited to the embodiments set forth herein. Rather, these embodiments are provided so that this disclosure will be thorough and complete, and will fully convey the scope of the embodiments to those skilled in the art. Among other things, the various embodiments can be methods, systems, media, or devices. The following detailed description is, therefore, not to be taken in a limiting sense.

Throughout the specification and claims, the following terms take the meanings explicitly associated herein, unless the context clearly dictates otherwise. The term “herein” refers to the specification, claims, and drawings associated with the current application. The phrase “in one embodiment” or “in an embodiment” as used herein does not necessarily refer to the same embodiment or a single embodiment, though it can. Furthermore, the phrase “in another embodiment” as used herein does not necessarily refer to a different embodiment, although it can. Thus, as described below, various embodiments can be readily combined, without departing from the scope or spirit of the invention.

In addition, as used herein, the term “or” is an inclusive “or” and is equivalent to the term “and/or” unless the context clearly dictates otherwise. The term “based on” is not exclusive and allows for being based on additional factors not described, unless the context clearly dictates otherwise. In addition, throughout the specification, the meaning of “a” “an” and “the” include plural references. The meaning of “in” includes “in” and “on.”

As used herein, the term “Host” can refer to an individual person, partnership, organization, or corporate entity that can own or operate one or more digital media properties (e.g., web sites, mobile applications, or the like). Hosts can arrange digital media properties to use hyper-local targeting by arranging the property to integrate with widget controllers, content management servers, or content delivery servers.

Briefly stated, various embodiments of a system, method, and computer program product for processing vehicle event data.

Embodiments are directed to a system and methods for processing geolocation event data points and mapping the event data to road segments. An ingestion server ingests location event data and processes the location event data to identify a road segment for a data point. A plurality of road segments, given as line segments, for an event lat/long data point are identified, and a penalty criterion is applied to a nearest-neighbor road segment of the plurality of road segments. The nearest neighbor road segment is disqualified from the selection if it meets the penalty criterion. The system is thus configured to penalize road segments that are not aligned in the direction of travel of the given data point by adding a fixed penalty to the actual distance between the point and the road segment. This makes road segments that do not align with the direction of travel to appear further away and therefore less likely to be selected as the correct one.

In an embodiment, the system can be configured to provide active vehicle detection. The processor can be configured to execute instructions for the active vehicle detection comprising identifying a vehicle path from a plurality of the events over a period of time. The processor can be configured to execute the instructions for the active vehicle detection comprising: identifying the vehicle path from the plurality of events over the period of a day, the identification comprising using a connected components algorithm.

In an embodiment, the system can be configured to provide active vehicle detection.

At least one embodiment is a method implemented by a computer including a processor, and a memory including program memory including instructions for executing the methods described above and herein.

### Illustrative Logical System Architecture and System Flows

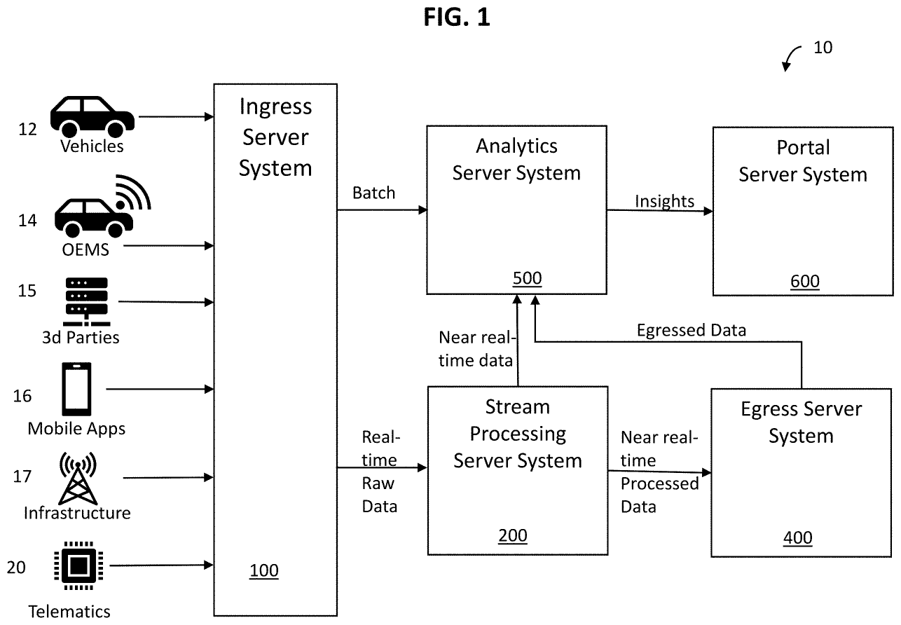

FIG. 1 is a logical architecture of system 10 for geolocation event processing and analytics in accordance with at least one embodiment. In at least one embodiment, Ingress Server system 100 can be arranged to be in communication with Stream Processing Server system 200 and Analytics Server system 500. The Stream Processing Server system 200 can be arranged to be in communication with Egress Server system 400 and Analytics Server system 500.

The Egress Server system 400 can be configured to be in communication with and provide data output to data consumers. The Egress Server system 400 can also be configured to be in communication with the Stream Processing Server 200.

The Analytics Server system 500 is configured to be in communication with and accept data from the Ingress Server system 100, the Stream Processing Server system 200, and the Egress Server system 400. The Analytics Server system 500 is configured to be in communication with and output data to a Portal Server system 600.

In at least one embodiment, Ingress Server system 100, Stream Processing Server system 200, Egress Server system 400, Analytics Server system 500, and Portal Server system 600 can each be one or more computers or servers. In at least one embodiment, one or more of Ingress Server system 100, Stream Processing Server system 200, Egress Server system 400, Analytics Server system 500, and Portal Server system 600 can be configured to operate on a single computer, for example a network server computer, or across multiple computers. For example, in at least one embodiment, the system 10 can be configured to run on a web services platform host such as Amazon Web Services (AWS) or Microsoft Azure. In an exemplary embodiment, the system 10 is configured on an AWS platform employing a Spark Streaming server, which can be configured to perform the data processing as described herein. In an embodiment, the system 10 can be configured to employ a high throughput messaging server, for example, Apache Kafka.

In at least one embodiment, Ingress Server system 100, Stream Processing Server system 200, Egress Server system 400, Analytics Server system 500, and Portal Server system 600 can be arranged to integrate and/or communicate using API's or other communication interfaces provided by the services.

In at least one embodiment, Ingress Server system 100, Stream Processing Server system 200, Egress Server system 400, Analytics Server system 500, and Portal Server system 600 can be hosted on Hosting Servers.

In at least one embodiment, Ingress Server system 100, Stream Processing Server system 200, Egress Server system 400, Analytics Server system 500, and Portal Server system 600 can be arranged to communicate directly or indirectly over a network to the client computers using one or more direct network paths including Wide Access Networks (WAN) or Local Access Networks (LAN).

One of ordinary skill in the art will appreciate that the architecture of system 10 is a non-limiting example that is illustrative of at least a portion of an embodiment. As such, more or less components can be employed and/or arranged differently without departing from the scope of the innovations described herein. However, system 10 is sufficient for disclosing at least the innovations claimed herein.

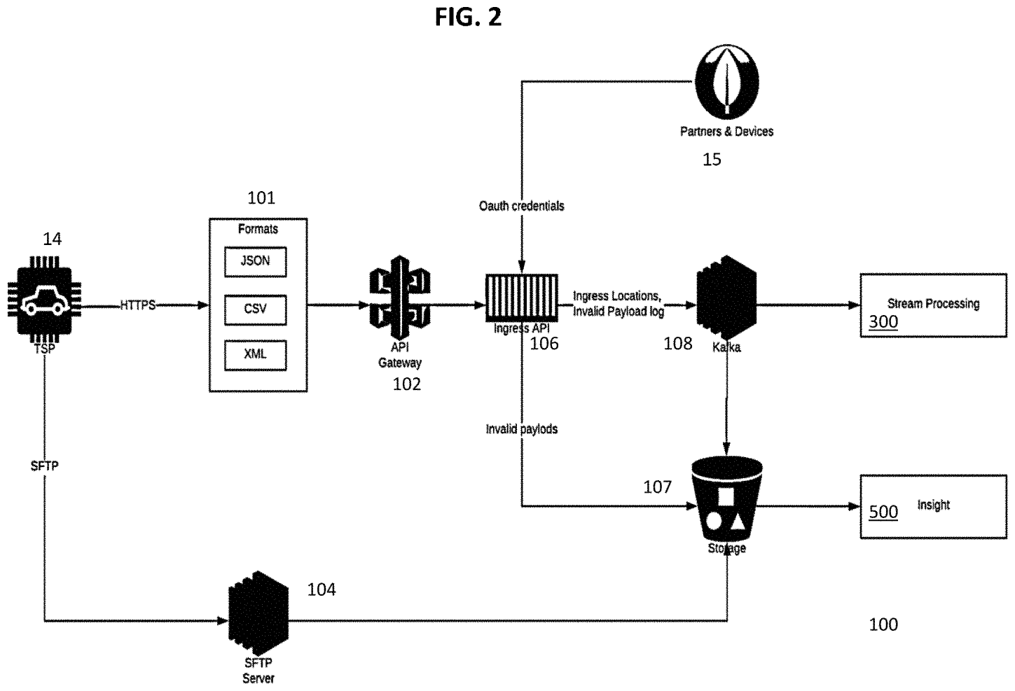

Referring to FIG. 2, a logical architecture for an Ingress Server system 100 for ingesting data and data throughput in accordance with at least one embodiment is shown. In at least one embodiment, events from one or more event sources can be determined. In an embodiment, as shown in FIG. 1, event sources can include vehicle sensor data source 12, OEM vehicle sensor data source 14, application data source 16, telematics data source 20, wireless infrastructure data source 17, and third party data source 15 or the like. In at least one embodiment, the determined events can correspond to location data, vehicle sensor data, various user interactions, display operations, impressions, or the like, that can be managed by downstream components of the system, such as Stream Processing Server system 200 and Analytics Server system 500. In at least one embodiment, Ingress Server system 100 can ingress more or fewer event sources than shown in FIGS. 1A-2.

In at least one embodiment, events that can be received and/or determined from one or more event sources includes vehicle event data from one or more data sources, for example GPS devices, or location data tables provided by third party data source 15, such as OEM vehicle sensor data source 14. Vehicle event data can be ingested in database formats, for example, JSON, CSV, and XML. The vehicle event data can be ingested via APIs or other communication interfaces provided by the services and/or the Ingress Server system 100. For example, Ingress Server system 100 can offer an API Gateway 102 interface that integrates with an Ingress Server API 106 that enables Ingress Server system 100 to determine various events that can be associated with databases provided by the vehicle event source 14. An exemplary API gateway can include, for example AWS API Gateway. An exemplary hosting platform for an Ingress Server system 100 system can include Kubernetes and Docker, although other platforms and network computer configurations can be employed as well.

In at least one embodiment, the Ingress Server system 100 includes a Server 104 configured to accept raw data, for example, a Secure File Transfer Protocol Server (SFTP), an API, or other data inputs can be configured accept vehicle event data. The Ingress Server system 100 can be configured to store the raw data in data store 107 for further analysis, for example, by an Analytics Server system 500. Event data can include Ignition on, time stamp (T1 . . . TN), Ignition off, interesting event data, latitude and longitude, and Vehicle Information Number (VIN) information. Exemplary event data can include Vehicle Movement data from sources as known in the art, for example either from vehicles themselves (e.g. via GPS, API) or tables of location data provided from third party data sources 15.

In at least one embodiment, the Ingress Server system 100 is configured to clean and validate data. For example, the Ingress Server 100 can be configured include Ingress API 106 that can validate the ingested telematics and location data and pass the validated location data to a server queue 108, for example, an Apache Kafka queue, which is then outputted to the Stream Processing Server 300. The server 108 can be configured to output the validated ingressed location data to the data store 107 as well. The Ingress Server can also be configured pass invalid data to a data store 107. For example, invalid payloads can be stored in data store 107. Exemplary invalid data can include, for example, data with bad fields or unrecognized fields, or identical events.

In an embodiment, the system 10 is configured to detect and map vehicle locations with enhanced accuracy. In order to gather useful aggregates about the road network, for example expected traffic volumes and speeds across the daily/weekly cycle, the system 10 can be configured to determine how vehicles are moving through a given road network. As noted herein, a naïve approach of associating or “snapping” each data point with a nearest section of a road can fail because vehicle GPS data has an inherent degree of error due to various known physical effects. Further, a road network often approaches and crosses itself in complicated geometries leading to locations with multiple road snapping candidates.

In an embodiment, the system 10 can be configured to include a base map given as a collection of line segments for road segments. The system 10 includes, for each line segment, geometrical information regarding the line segment's relation to its nearest neighbors. For each line segment, statistical information regarding expected traffic volumes and speeds is generated from an initial iteration of the process. As shown above, vehicle movement event data comprises longitude, latitude, heading, speed and time-of-day.

In an embodiment, the system 10 is configured to take a collection of line segments, which corresponds to road segments, and create an R-Tree index over the collection of line segments. R-trees are tree data structures used for spatial access methods, i.e., for indexing multi-dimensional information such as geographical coordinates, rectangles or polygons. The R-tree is configured to store spatial objects as bounding box polygons to represent, inter alia, road segments. The R-Tree is first used to find road segment candidates within a prescribed distance of a coordinate in order to snap a data point. The candidates are then further examined using a refined metric that considers event data such as the heading select a road segment, which is most likely based on all known information. Event data such as speed and/or time-of-day can also be employed to select a road segment.

In an embodiment, the system 10 can also be configured to penalize road segments that are not aligned in the direction of travel of the given data point by adding a fixed penalty to the actual distance between the point and the road segment. This makes line segments that do not align with the direction of travel to appear further away and therefore less likely to be selected as the correct one. In cases where there is still some question over which segment is the best fit, the system 10 can be configured to weigh additional information regarding the expected speed of the given point and additional geometrical considerations before selection takes place.

The system 10 is configured to predefine distances between bounding box road segments, for example using an R-tree as described above. For precalculated distances for the road segments, the system 10 can be configured to select a nearest neighbor for a closest distance. In an embodiment, the system 10 can also be configured to add a penalty to determine if the road segment with the closest distance is the correct road segment for the vehicle.

The system 10 is configured to identify a distance between a point (lat/long) and a road segment (line segment). An Item Distance artery implementation allows any two points in distance to be identified to a road segment. In an embodiment, the system can also be configured to implement a penalty for a heading in order to override choosing a road segment based on a naïve or default selection of a closest point from the lat/long data point. As noted above, a road segment can be defined as a bounding box or line segment.

For example, the system 10 can be configured to allow an angular range of deviation between a car heading and road heading to determine whether to apply a penalty in selecting the road segment. For example, where the deviation is small, no penalty is applied, as the car heading and the road heading are highly likely to be accurate when the angle of deviation is small Thus, the system 10 can be configured to choose a smallest angle to identify a segment heading. However, if the smallest angle is less than a predetermined angle, for example in the range of 10-40 degrees out of 360 degrees, the system 10 can be configured to select that road segment or preferentially weight that road segment for selection.

In an embodiment, other event data can be employed to weight the selection of the penalty, for example the speed of vehicle (mph). For instance, when a vehicle speed indicates a high speed a high angle of deviation, the penalty can be applied. If the road heading is more than 30 degrees from the car heading, and the speed is higher than the a given speed threshold, it is highly likely that the road segment is not accurate, and so the penalty should be applied. On the other hand, if the angle of deviation between the car heading and the road heading is small and the speed is high, it is highly likely that the vehicle is indeed moving in the proper direction at that speed.

Accordingly, in an embodiment, an angle differential, for example over 30 degrees and under 180 degrees for a heading, can be employed to determine a “one way” or “wrong way” penalty using directional information from associated map data for a road segment. For example, if a closest point between the two points for selecting a road segment results in angle differential between 30 degrees to 150 degrees, and that angle would place the vehicle on the wrong direction for the segment, the system can be configured to apply a wrong way penalty.

An exemplary penalty algorithm is as follows:

```
class CarCoords(val longitude:Double, val latitude:Double, val heading: Double, val speed: Double) {
}
  class RoadSegmentDistance(wrongWayPenalty: Double) extends ItemDistance with Serializable {
        def distance(i_rs: ItemBoundable, i_coords: ItemBoundable) :Double = {
          val coords = i_coords.getItem( ).asInstanceOf[CarCoords]
          val rs = i_rs.getItem( ).asInstanceOf[RoadSegment]
            snap_result(rs, coords, false)._6
      }
        def snap_result(rs: RoadSegment, coords:CarCoords, use_haversine:Boolean) = {
          val pt = new Coordinate(coords.longitude, coords.latitude)
          val lln = new LocationIndexedLine(rs.line)
          val projected_linearlocation = lln.project(pt)
          val segment = projected_linearlocation.getSegment(rs.line)
          val snappedpt = lln.extractPoint(projected_linearlocation)
            val segment_heading = (450 - math.toDegrees(segment.angle)) % 360
            val angle_diff = if (math.abs(segment_heading - coords. heading) < 180) math.abs(segment_heading -
coords.heading) else 360 - math.abs(segment_heading - coords.heading)
          val wrong_way = if (rs.oneway != 0 [symbol]     angle_diff > 30) 1
          else if (rs.oneway == 0 [symbol]     angle_diff > 30 [symbol]     angle_diff < 150) 1
          else 0
            val distance = if (!use_haversine) pt.distance(snappedpt) else {
              1000 * EARTH_EQUATORIAL_RADIUS_KM *
                distHaversineRAD(
                  DEGREES_TO_RADIANS *pt.y,
                  DEGREES_TO_RADIANS * pt.x,
                  DEGREES_TO_RADIANS * snappedpt.y,
                  DEGREES_TO_RADIANS * snappedpt.x)
          }
            val penalised_distance = wrongWayPenalty * wrong_way + distance
            (rs.id, snappedpt.x, snappedpt.y, distance, segment_heading, penalised_distance, rs.oneway != 0, rs.road_type)
      }
    }
```

The output from the algorithm comprises: a road segment chosen as the best match; a new (longitude, latitude) pair that represents the original point snapped to the chosen line segment; and the error or distance between the original point and the snapped point. As noted above, the system 10 is configured to apply a penalty to obtain the most likely road segment.

In an embodiment, the algorithm can also include a measure of confidence in the chosen road segment based on the number of other potential matches that closely match the criteria for selection. For example, a weight could comprise a road knowledge weight, for example, time-of-day, miles-per-hour and/or road type weight. For instance, a road knowledge weight might include a highway or residential road weight. Thus, if a road segment is known to be a residential segment, a selection could be weighted to penalize choosing a nearest highway segment when a vehicle is identified as going 30 miles per hour.

The Ingress Server 100 can be configured to output the stored invalid data or allow stored data to be pulled to the Analysis Server 500 from the data store 107 for analysis, for example, to improve system performance. For example, the Analysis Server 500 can be configured with diagnostic machine learning configured to perform analysis on databases of invalid data with unrecognized fields to newly identify and label fields for validated processing. The Ingress Server 100 can also be configured to pass stored ingressed location data for processing by the Analytics server 500, for example, for Journey analysis as described herein.

In an embodiment, the Ingress Server 100 is configured to process event data to derive vehicle movement data, for example speed, duration, and acceleration. For example, in an embodiment, a snapshot is taken on the event database every x number of seconds (e.g. 3 seconds). Lat/long data and time data can then be processed to derive vehicle tracking data, such as speed and acceleration, using vehicle position and time.

In an embodiment, the Ingress Server system 100 is configured to accept data from devices and third party platforms. The Ingress Server API 106 can be configured to authenticate devices and partner or third-party platforms and platform hosts to the system 10.

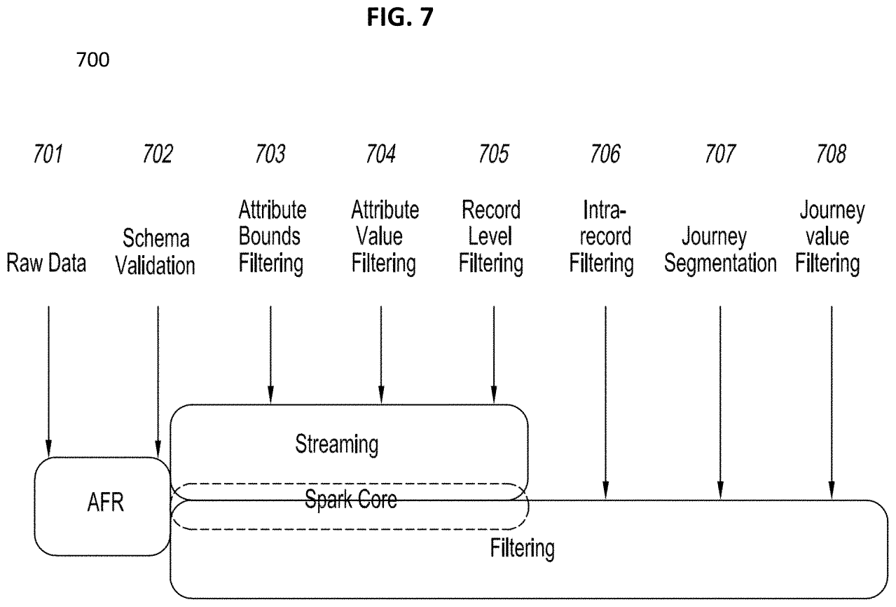

Accordingly, in an embodiment, the Ingress Server system 100 is configured to receive raw data and perform data quality checks for raw data and schema evaluation. Ingesting and validating raw data is the start of a data quality pipeline of quality checks for the system as shown in FIG. 7 at block 701. Table 1 shows an example of raw data that can be received into the system 10.

TABLE 1

| | Attribute | Type | Nullable | Description |
|---|---|---|---|---|
| Raw | partner_id | Integer | No | Identifier for ingress |
| Data. | | | | partner |
| | device_id | String | Yes | 4-9 characters long |
| | captured_timestamp | String | No | Time of an event, |
| | | | | expressed in local |
| | | | | time with UTC offset |
| | received_timestamp | String | No | Time event was received |
| | | | | by Ingress Server, UTC |
| | longitude, latitude | Double | No | WGS84 coordinates of |
| | | | | an event |
| | speed | Float | No | Vehicle speed in |
| | | | | kilometers per hour |
| | | | | recorded at the time |
| | | | | of an event |
| | additional | Map | No | Map of string key-value |
| | | | | pairs to express data |
| | | | | attributes unique to |
| | | | | each ingress |
| | journey_id | String | No | An identifier for a |
| | | | | journey and the |
| | | | | associated events within it |
| | heading | Integer | Yes | Clockwise orientation of |
| | | | | vehicle, 0 equals North |
| | altitude | Integer | Yes | Elevation of vehicle as |
| | | | | reported by GPS |
| | squish_vin | String | Yes | Encoded representation |
| | | | | of vehicle make/model |
| | | | | characteristics |
| | ignition_status | String | Yes | Indicator of whether |
| | | | | vehicle is under power |

In another embodiment, vehicle event data from an ingress source can include less information. For example, as shown in Table 2, the raw vehicle event data can comprise a limited number of attributes, for example, location data (longitude and latitude) and time data (time stamp s).

TABLE 2

| | Attribute | Type | Nullable | Description |
|---|---|---|---|---|
| Raw | captured_timestamp | String | No | Time of an event, |
| Data. | | | | expressed in local time |
| | | | | with UTC offset |
| | received_timestamp | String | No | Time event was |
| | | | | received by Ingress |
| | | | | Server, UTC |
| | longitude, latitude | Double | No | WGS84 coordinates |
| | | | | of an event |

An exemplary advantage of embodiments of the present disclosure is that information that is absent can be derived from innovative algorithms as described herein. For example, vehicle event data may not include a journey identification, or may have a journey identification that is inaccurate. Accordingly, the system 10 can be configured to derive additional vehicle event attribute data when the initially ingressed data has limited attributes. For example, the system 10 can be configured to identify a specific vehicle for ingressed vehicle event data and append a Vehicle ID. The system 10 can thereby trace vehicle movement including starts and stops, speed, heading, acceleration, and other attributes using, for example, only location and timestamp data associated with a Vehicle ID.

In an embodiment, at block 702, data received can conform to externally defined schema, for example, Avro or JSON. The data can be transformed into internal schema and validated. In an embodiment, event data can be validated against an agreed schema definition before being passed on to the messaging system for downstream processing by the data quality pipeline. For example, an Apache Avro schema definition can be employed before passing the validated data on to an Apache Kafka messaging system. In another embodiment, the raw movement and event data can also be processed by a client node cluster configuration, where each client is a consumer or producer, and clusters within an instance can replicate data amongst themselves.

For example, the Ingress server system 100 can be configured with a Pulsar Client connected to an Apache Pulsar end point for a Pulsar cluster. In an embodiment, the Apache Pulsar end point keeps track of the last data read, allowing an Apache Pulsar Client to connect at any time to pick up from the last data read. In Pulsar, a “standard” consumer interface involves using “consumer” clients to listen on topics, process incoming messages, and finally acknowledge those messages when the messages have been processed. Whenever a client connects to a topic, the client automatically begins reading from the earliest unacknowledged message onward because the topic's cursor is automatically managed by a Pulsar Broker module. However, a client reader interface for the client enables the client application to manage topic cursors in a bespoke manner. For example, a Pulsar client reader can be configured to connect to a topic to specify which message the reader begins reading from when it connects to a topic. When connecting to a topic, the reader interface enables the client to begin with the earliest available message in the topic or the latest available message in the topic. The client reader can also be configured to begin at some other message between the earliest message and the latest message, for example by using a message ID to fetch messages from a persistent data store or cache.

In at least one embodiment, the Ingress Server system 100 is configured to clean and validate data. For example, the Ingress Server system 100 can be configured include an Ingress Server API 106 that can validate the ingested vehicle event and location data and pass the validated location data to a server queue 108, for example, an Apache Kafka queue, which is then outputted to the Stream Processing Server system 200. Server 104 can be configured to output the validated ingressed location data to the data store 107 as well. The Ingress Server system 100 can also be configured to pass invalid data to a data store 107.

Data store 107 can also store a map database. The map database can be, for example, a point of interest database or other map database, including public or proprietary map databases. Exemplary map databases can include extant street map data such as Geofabric for local street maps, or World Map Database. The system can be further configured to egress the data to external mapping interfaces, navigation interfaces, traffic interfaces, and connected car interfaces as described herein.

In an embodiment, at block 702, data received can conform to externally defined schema, for example, Avro or JSON. The Ingress Server system 100 can be configured to output the stored invalid data or allow stored data to be pulled to the Analysis Server system 500 from the data store 107 for analysis, for example, to improve system performance. For example, the Analysis Server system 500 can be configured with diagnostic machine learning configured to perform analysis on databases of invalid data with unrecognized fields to newly identify and label fields for validated processing. The Ingress Server system 100 can also be configured to pass stored ingressed location data for processing by the Analytics Server system 500, for example, for Journey analysis as described herein.

As described herein, the system 10 is configured to process data in both a streaming and a batch context. In the streaming context, low latency is more important than completeness, i.e. old data need not be processed, and in fact, processing old data can have a detrimental effect as it may hold up the processing of other, more recent data. In the batch context, completeness of data is more important than low latency. Accordingly, to facilitate the processing of data in these two contexts, in an embodiment, the system 10 can default to a streaming connection that ingresses all data as soon as it is available but can also be configured to skip old data. A batch processor can be configured to fill in any gaps left by the streaming processor due to old data.

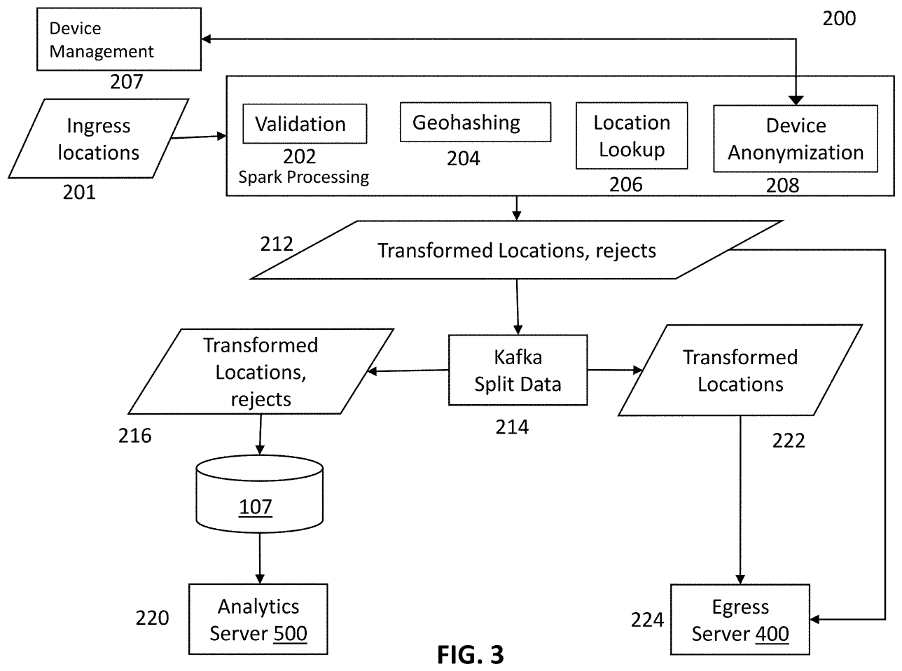

FIG. 3 is a logical architecture for a Stream Processing Server system 200 for data throughput and analysis in accordance with at least one embodiment. Stream processing as described herein results in system processing improvements, including improvements in throughput in linear scaling of at least 200 k to 600 k records per second. Improvement further includes end-to-end system processing of 20 seconds, with further improvements to system latency being ongoing. In at least one embodiment, the system 10 can be configured to employ a server for micro-batch processing. For example, as described herein, in at least one embodiment, the Stream Processing Server system 200 can be configured to run on a web services platform host such as AWS employing a Spark Streaming server and a high throughput messaging server such as Apache Kafka. In an embodiment, the Stream Processing Server system 200 can include Device Management Server 207, for example, AWS Ignite, which can be configured input processed data from the data processing server. The Device Management Server 207 can be configured to use anonymized data for individual vehicle data analysis, which can be offered or interfaced externally. The system 10 can be configured to output data in real time, as well as to store data in one or more data stores for future analysis. For example, the Stream Processing Server system 200 can be configured to output real time data via an interface, for example Apache Kafka, to the Egress Server system 400. The Stream Processing Server system 200 can also be configured to store both real-time and batch data in the data store 107. The data in the data store 107 can be accessed or provided to the Insight Server system 500 for further analysis.

In at least one embodiment, event information can be stored in one or more data stores 107, for later processing and/or analysis. Likewise, in at least one embodiment, event data and information can be processed as it is determined or received. Also, event payload and process information can be stored in data stores, such as data store 107, for use as historical information and/or comparison information and for further processing.

In at least one embodiment, the Stream Processing Server system 200 is configured to perform vehicle event data processing.

FIG. 3 illustrates a logical architecture and overview flowchart for a Steam Processing Server system 200 in accordance with at least one embodiment. At block 202, the Stream Processing Server system 200 performs validation of location event data from ingressed locations 201. Data that is not properly formatted, is duplicated, or is not recognized is filtered out. Exemplary invalid data can include, for example, data with bad fields, unrecognized fields, or identical events (duplicates) or engine on/engine e off data points occurring at the same place and time. The validation also includes a latency check, which discards event data that is older than a predetermined time period, for example, 7 seconds. In an embodiment, other latency filters can be employed, for example between 4 and 15 seconds.

In an embodiment, as shown at block 703 of FIG. 7, the Stream Processing Server system 200 is configured perform Attribute Bounds Filtering. Attribute Bounds Filtering checks to ensure event data attributes are within predefined bounds for the data that is meaningful for the data. For example, a heading attribute is defined as a circle (0→359). A squish-vin is a 9-10 character VIN. Examples include data that is predefined by a data provider or set by a standard. Data values not within these bounds indicate the data is inherently faulty for the Attribute. Non-conforming data can be checked and filtered out. An example of Attribute Bounds Filtering is given in Table 3.

TABLE 3

| | | | | | | | Data |
|---|---|---|---|---|---|---|---|
| | | | | | | Data | Points |
| | | | | Defined | | Points | Flagged |
| | | Attribute | Units | by | Bounds | Flagged | (%) |
| Attribute | Attributes | device_id | String | Externally | N/A | 27 | 0.00171% |
| Bounds | contain | longitude, | Double | Internally | to spec | 586 | 586 |
| Filtering | only values | latitude | | | | | |
| Values | within | heading | Integer | Externally | 0 → 359 | 94 | 0.00004% |
| within | externally | squish_ | String | Externally | 9-10 | 0 | 0% |
| meaningful | predefined | vin | | | characters | | |
| range. | boundaries. | | | | | | |

In an embodiment, at block 704 the system 10 is configured to perform Attribute Value Filtering. Attribute Value Filtering checks to ensure attribute values are internally set or bespoke defined ranges. For example, while a date of 1970 can pass an Attribute Bounds Filter check for a date Attribute of the event, the date is not a sensible value for vehicle tracking data. Accordingly, Attribute Value Filtering is configured to filter data older than a predefined time, for example 6 weeks or older, which can be checked and filtered. An example Attribute Bounds Filtering is given in Table 3.

TABLE 3

| | | | | | | | Data |
|---|---|---|---|---|---|---|---|
| | | | | | | Data | Points |
| | | | | Defined | | Points | Flagged |
| | | Attribute | Units | by | Bounds | Flagged | (%) |
| Attribute | Attributes | captured_ | Timestamp | | <6 weeks | | 64296 |
| Bounds | contain | timestamp | | | ago | | |
| Filtering | only values | received_ | Timestamp | | > now | | 0 |
| Values | within | timestamp | | | | | |
| within | internally | longitude, | degrees | Internally | bounding | | 0 |
| reasonable | defined | latitude | | | box | | |
| range. | boundaries. | Speed | kph | Internally | 0 → 360 | | 0 |
| | | Altitude | metres | Internally | −1000 → 10000 | | |

At block 705, the system 10 can perform further validation on Attributes in a record to confirm that relationships between attributes of record data points are coherent. For example, a non-zero trip start event does not make logical sense for a Journey determination as described herein. Accordingly, as shown in Table 4, the system 10 can be configured to filter non-zero speed events recorded for the same Attributes for a captured timestamp and a received timestamp for a location as “TripStart” or Journey ignition on start event.

TABLE 4

| | | | | Data |
|---|---|---|---|---|
| | | | Data | Points |
| | | | Points | Flagged |
| | Attributes | Conditions | Flagged | (%) |
| Record- | speed, | speed > 0 AND | 439 | 0.0004% |
| Level | ignition_ | ignition_status IN | | |
| Filtering | status | (′KEY_OFF′,′KEY_ON′) | | |
| Row | captured_ | received_timestamp < | 41 | 0.00004% |
| contents | timestamp, | | | |
| have | received_ | captured_timestamp | | |
| semantic | timestamp | | | |
| meaning. | | | | |

Returning to FIG. 2, at block 204, in at least one embodiment, the Stream Processing Server 200 performs geohashing of the location event data. While alternatives to geohashing are available, such as an H3 algorithm as employed by Uber™, or a S2 algorithm as employed by Google™, it was found that geohashing provided exemplary improvements to the system 10, for example improvements to system latency and throughput. Geohashing also provided for database improvements in system 10 accuracy and vehicle detection. For example, employing a geohash to 9 characters of precision can allow a vehicle to be uniquely associated the geohash. Such precision can be employed in Journey determination algorithms as described herein. In at least one embodiment, the location data in the event data is encoded to a proximity, the encoding comprising geohashing latitude and longitude for each event to a proximity for each event. The event data comprises time, position (lat/long), and event of interest data. Event of interest data can include harsh brake and harsh acceleration. For example, a harsh brake can be defined as a deceleration in a predetermined period of time (e.g. 40-0 in x seconds), and a harsh acceleration is defined as an acceleration in a predetermined period of time (e.g. 40-80 mph inx seconds). Event of interest data can be correlated and processed for employment in other algorithms. For example, a cluster of harsh brakes mapped in location to a spatiotemporal cluster can be employed as a congestion detection algorithm.

The geohashing algorithm encodes latitude and longitude (lat/long) data from event data to a short string of n characters. In an embodiment, the geohashed lat/long data is geohashed to a shape. For example, in an embodiment, the lat/long data can be geohashed to a rectangle whose edges are proportional to the characters in the string. In an embodiment, the geohash can be encoded from to 4 to 9 characters.

A number of advantages flow from employing geohashed event data as described herein. For example, in a database, data indexed by geohash will have all points for a given rectangular area in contiguous slices, where the number of slices is determined by the geohash precision of encoding. This improves the database by allowing queries on a single index, which is much easier or faster than multiple-index queries. The geohash index structure is also useful for streamlined proximity searching, as the closest points are often among the closest geohashes.

At block 206, in at least one embodiment, the Stream Processing Server system 200 performs a location lookup. As noted above, in an embodiment, the system 10 can be configured to encode the geohash to identify a defined geographical area, for example, a country, a state, or a zip code. The system 10 can geohash the lat/long to a rectangle whose edges are proportional to the characters in the string.

For example, in an embodiment, the geohashing can be configured to encode the geohash to 5 characters, and the system 10 can be configured to identify a state to the 5-character geohashed location. For example, the geohash encoded to 5 slices or characters of precision is accurate to +/−2.5 kilometers, which is sufficient to identify a state. A geohash to 6 characters can be used to identify the geohashed location to a zip code, as it is accurate to +/−0.61 kilometers. A geohash to 4 characters can be used to identify a country. In an embodiment, the system 10 can be configured to encode the geohash to uniquely identify a vehicle with the geohashed location. In an embodiment, the system 10 can be configured to encode the geohash to 9 characters to uniquely identify a vehicle.

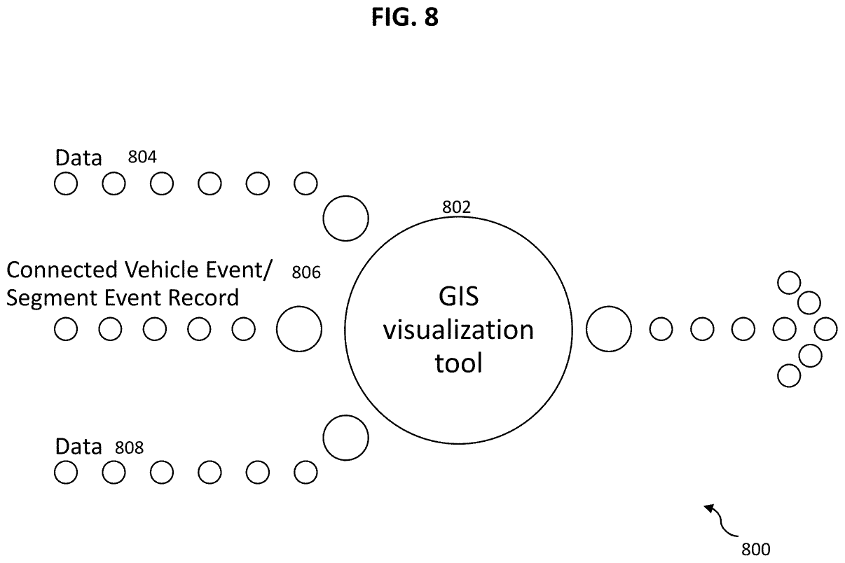

In an embodiment, the system 10 can be further configured to map the geohashed event data to a map database. The map database can be, for example, a point of interest database or other map database, including public or proprietary map databases. Exemplary map databases can include extant street map data such as Geofabric for local street maps, or World Map Database. The system 10 can be further configured to produce mapping interfaces. An exemplary advantage of employing geohashing as described herein is that it allows for much faster, low latency enrichment of the vehicle event data when processed downstream. For example, geographical definitions, map data, and other enrichments are easily mapped to geohashed locations and Vehicle IDs. Feed data can be also be combined into an aggregated data set and visualized using an interface, for example a GIS visualization tool as shown in FIG. 8 (e.g.: Mapbox, CARTO, ArcGIS, or Google Maps API) or other interfaces to produce and interface graphic reports or to output reports to third parties 15 using the data processed to produce the analytics insights, for example, via the Egress Server system 400 or Portal Server system 600.

In at least one embodiment, at block 208, the Stream Processor Server system 200 can be configured to anonymize the data to remove identifying information, for example, by removing or obscuring personally identifying information from a Vehicle Identification Number (VIN) for vehicle data in the event data. In various embodiments, event data or other data can include VIN numbers, which include numbers representing product information for the vehicle, such as make, model, and year, and also includes characters that uniquely identify the vehicle, and can be used to personally identify it to an owner. The system 10 can include, for example, an algorithm that removes the characters in the VIN that uniquely identify a vehicle from vehicle data but leaves other identifying serial numbers (e.g. for make, model and year), for example, a Squish Vin algorithm. In an embodiment, the system 10 can be configured to add a unique vehicle tag to the anonymized data. For example, the system 10 can be configured to add unique numbers, characters, or other identifying information to anonymized data so the event data for a unique vehicle can be tracked, processed and analyzed after the personally identifying information associated with the VIN has been removed. An exemplary advantage of anonymized data is that the anonymized data allows processed event data to be provided externally while still protecting personally identifying information from the data, for example as may be legally required or as may be desired by users.

In at least one embodiment, as described herein, a geohash to 9 characters can also provide unique identification of a vehicle without obtaining or needing personally identifying information such as VIN data. Vehicles can be identified via processing a database event data and geohashed to a sufficient precision to identify unique vehicles, for example to 9 characters, and the vehicle can then be identified, tracked, and their data processed as described herein.

In an embodiment, data can be processed as described herein. For example, un-aggregated data can be stored in a database (e.g. Parquet) and partitioned by time. Data can be validated in-stream and then reverse geocoded in-stream. Data enrichment, for example by vehicle type, can be performed in-stream. The vehicle event data can aggregated, for example, by region, by journey, and by date. The data can be stored in Parquet, and can also be stored in Postgres. Reference data can be applied in Parquet for in-stream merges. Other reference data can be applied in Postgres for spatial attributes.

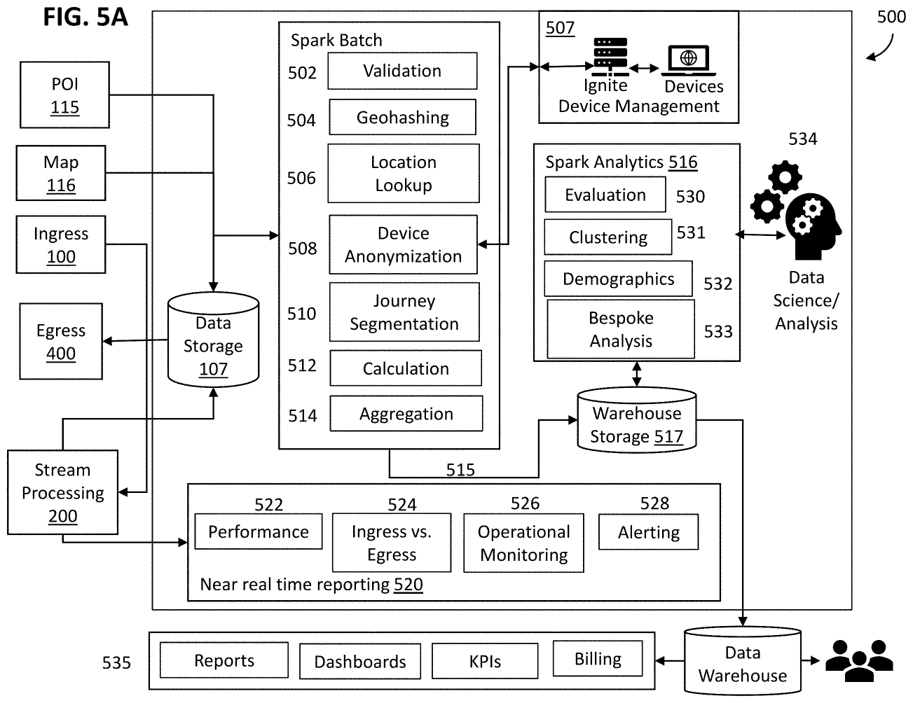

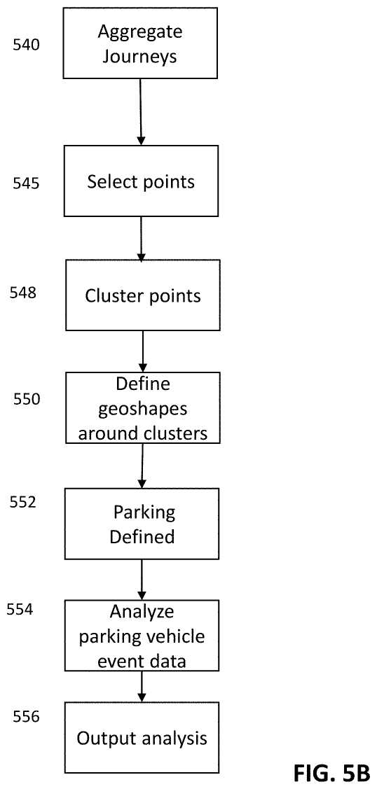

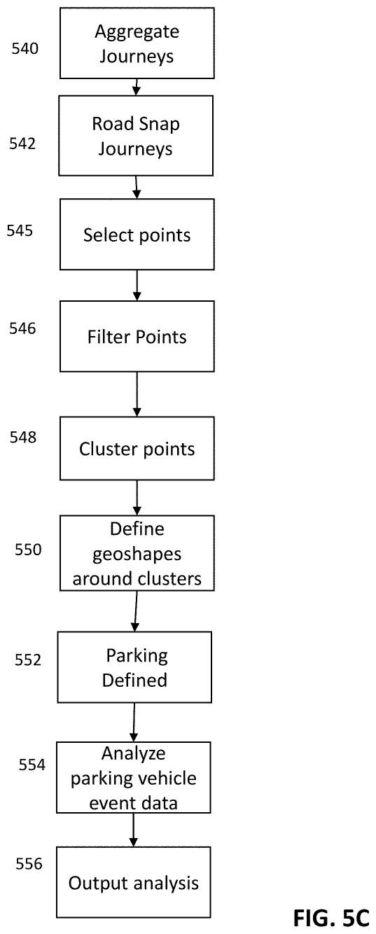

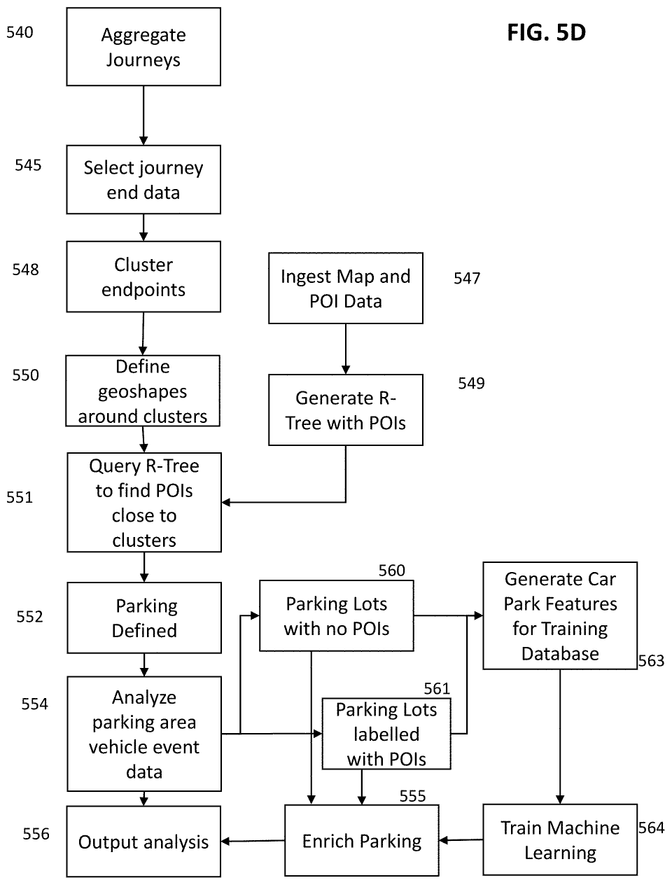

As noted above, for real-time streaming, at block 202, the data validation filters out data that has excess latency, for example a latency over 7 seconds. However, batch data processing can run with a full set of data without gaps, and thus can include data that is not filtered for latency. For example, a batch data process for analytics as described with respect to FIG. 5 can be configured to accept data up to 6 weeks old, whereas the streaming stack of Stream Processing Server system 200 is configured to filter data that is over 7 seconds old, and thus includes the latency validation check at block 202 and rejects events with higher latency.

In an embodiment, at block 212, both the transformed location data filtered for latency and the rejected latency data are input to a server queue, for example, an Apache Kafka queue. At block 214, the Stream Processing server system 200 can split the data into a data set including full data 216—the transformed location data filtered for latency and the rejected latency data—and another data set of the transformed location data 222. The full data 216 is stored in data store 107 for access or delivery to the Analytics Server system 500, while the filtered transformed location data is delivered to the Egress Server system 400. In another embodiment, the full data set or portions thereof including the rejected data can also be delivered to the Egress Server system 400 for third party platforms for their own use and analysis. In such an embodiment, at block 213 transformed location data filtered for latency and the rejected latency data can be provided directly to the Egress Server system 400.

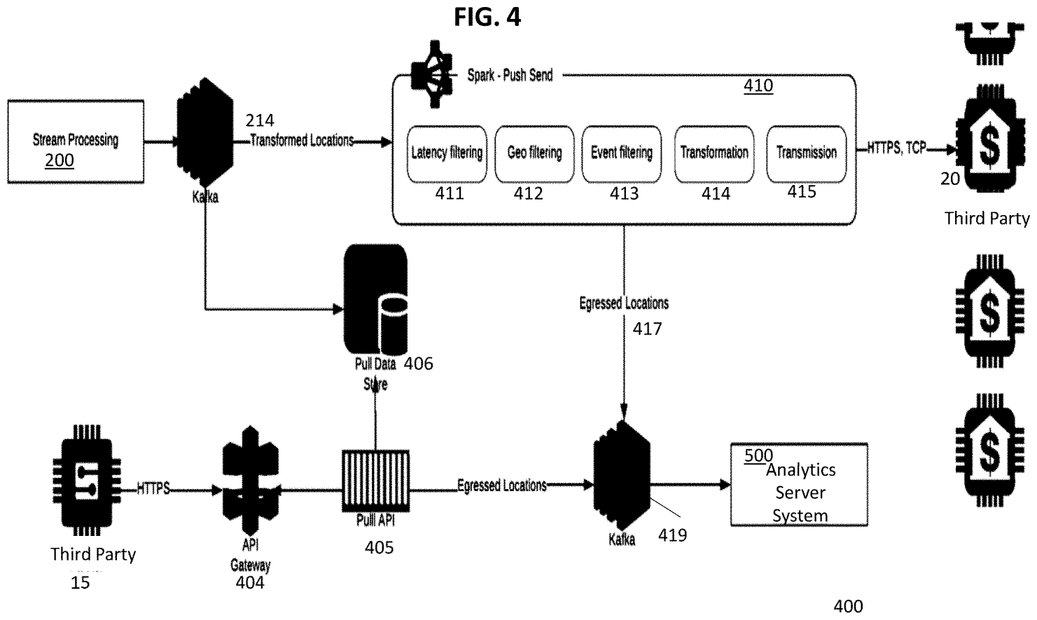

FIG. 4 is a logical architecture for and Egress Server system 400. In at least one embodiment, Egress Server system 400 can be one or more computers arranged to ingest, throughput records, and output event data. The Egress Server system 400 can be configured to provide data on a push or pull basis. For example, in an embodiment, the system 10 can be configured to employ a server Push server 402 from an Apache Spark Cluster or a distributed server system for parallel processing via multiple nodes, for example a Scala or Java platform on an Akka Server Platform. The push server can be configured to process transformed location data from the Stream Process Server system 200, for example, for latency filtering 411, geo filtering 412, event filtering 413, transformation 414, and transmission 415. As described herein, geohashing improves system 10 throughput latency considerably, which allows for advantages in timely push notification for data processed in close proximity to events, for example within minutes and even seconds. For example, in an embodiment, the system 10 is configured to target under 60 seconds of latency. As noted above, Stream Processing Server system 200 is configured to filter events with a latency of less than 7 seconds, also improving throughput. In an embodiment, a data store 406 for pull data can be provided via an API gateway 404, and a Pull API 405 can track which third part 15 users are pulling data and what data users are asking for.

For example, in an embodiment, the Egress Server system 400 can provide pattern data based on filters provided by the system 10. For example, the system 10 can be configured to provide a geofence filter 412 to filter event data for a given location or locations. As will be appreciated, geofencing can be configured to bound and process journey and event data as described herein for numerous patterns and configurations. For example, in an embodiment, the Egress Server system 400 can be configured to provide a “Parking” filter configured restrict the data to the start and end of journey (Ignition key on/off events) within the longitude/latitudes provided or selected by a user. Further filters or exceptions for this data can be configured, for example by state (state code or lat/long). The system 10 can also be configured with a “Traffic” filter to provide traffic pattern data, for example, with given states and lat/long bounding boxes excluded from the filters.

In an embodiment, the Egress Server 400 can be configured to process data with low-latency algorithms configured to maintain and improve low latency real-time throughput. The algorithms can be configured to process the data for low-latency file output that can populate downstream interfaces requiring targeted, real-time data that does not clog computational resources or render them inoperable. In an embodiment, the system 10 is configured to provide low latency average road speed data for road segments for output in virtually real time from a live vehicle movement data stream from the Stream Processing Server 200. The Egress Server 400 can also be configured to delete raw data in order and provide lightweight data packages to partners 20 and configured for downstream interfaces, for example via the Push Server 402.

FIG. 5A represents a logical architecture for an Analytics Server system 500 for data analytics and insight. In at least one embodiment, Analytics Server system 500 can be one or more computers arranged to analyze event data. Both real-time and batch data can be passed to the Analytics Server system 500 for processing from other components as described herein. In an embodiment, a cluster computing framework and batch processor, such as an Apache Spark cluster, which combines batch and streaming data processing, can be employed by the Analytics Server system 500. Data provided to the Analytics Server system 500 can include, for example, data from the Ingress Server system 100, the Stream Processing Server system 200, and the Egress Server system 400.

In an embodiment, the Analytics Server system 500 can be configured to accept vehicle event payload and processed information, which can be stored in data stores, such as data stores 107. As shown in FIG. 5A, the storage includes real-time egressed data from the Egress Server system 400, transformed location data and reject data from the Stream Processing Server system 200, and batch and real-time, raw data from the Ingress Server system 100. As shown in FIG. 2, ingressed locations stored in the data store 107 can be output or pulled into the Analytics Server system 500. The Analytics Server system 500 can be configured to process the ingressed location data in the same way as the Stream Processor Server system 200 as shown in FIG. 2. As noted above, the Stream Processing Server system 200 can be configured to split the data into a full data set 216 including full data (transformed location data filtered for latency and the rejected latency data) and a data set of transformed location data 222. The full data set 216 is stored in data store 107 for access or delivery to the Analytics Server system 500, while the filtered transformed location data is delivered to the Egress Server system 400. As shown in FIG. 5, real time filtered data can be processed for reporting in near real time, including reports for performance 522, Ingress vs. Egress 524, operational monitoring 526, and alerts 528.

Accordingly, at block 502 of FIG. 5A, in at least one embodiment, the Analytics Processing Server system 500 can be configured to optionally perform validation of raw location event data from ingressed locations in the same manner as shown with block 202 in FIG. 2 and blocks 701-705 of FIG. 7. In an embodiment, as shown in FIG. 7, at block 706, the system 10 can employ batch processing of records to perform further validation on Attributes for multiple event records to confirm that intra-record relationships between attributes of event data points are meaningful. For example, as shown in Table 5, the system 10 can be configured to analyze data points analyzed to ensure logical ordering of events for a journey (e.g.: journey events for a journey alternate “TripStart TripEnd TripStart” and do not repeat “TripStart-TripStart-TripEnd-TripEnd).

TABLE 5

| | | | Data | |
|---|---|---|---|---|
| | | | Points | Data Points |
| | Attributes | Conditions | Flagged | Flagged (%) |
| Intra- | ignition_status | LEAD | 9125 | 0.0035% |
| Record | | (ignition_status) = | | |
| Filtering | | ignition_status AND | | |
| Record | | ignition_status < > | | |
| ordering | | ′MID_JOURNEY′ | | |
| logical. | | | | |

Referring to block 504 of FIG. 5A, in at least one embodiment, the Analytics Server system 500 can optionally be configured to perform geohashing of the location event data as shown in FIG. 2, block 204. At block 506 of FIG. 5A, the Analytics Server system 500 can optionally perform location lookup. At block 508 of FIG. 5A, the Analytics Server system 500 can be configured to optionally perform device anonymization as shown in blocks 206 and 208 of FIG. 2.

Returning to FIG. 5A, at block 510, in at least one embodiment, the Analytics Server system 500 performs a Journey Segmentation analysis of the event data. In an embodiment, the system 10 is configured to identify a Journey for a vehicle from the event data, including identifying whether a given vehicle's route or movement is for purposes of driving to a journey destination, wherein the journey identification comprises: identifying an engine on or a first movement for the vehicle; identifying an engine off or stop movement for the vehicle; identifying a dwell time for a vehicle; and identifying a minimum duration of travel.

In at least one embodiment, a Journey can comprise one or more Journey Segments from a starting point to a final destination. A Journey Segment comprises a distance and a duration of travel between engine on/start movement and engine off/stop movement events for a vehicle.

However, a real driver may have one or more stops when travelling to a destination. A Journey can have two or more Journey Segments, such as when there is a trip with multiple stops. For example, a driver may need to stop for fuel when travelling from home to work or stop at a traffic light. As such, a problem and challenge in vehicle event analysis includes developing accurate vehicle tracking for embodiments as described herein. While other Journey algorithms or processes have been employed in the art, for example reverse engineering a journey from a known destination of an identified vehicle, the present disclosure includes embodiments and algorithms that have been developed and advantageously implemented for agnostic vehicle tracking using the technology described herein, including the data analysis, databases, interfaces, data processing, and other technological products.

At block 512, the Analytics Server 500 is configured to perform calculations to qualify a Journey from event information. In an embodiment, the system 10 is configured with Journey detection criteria, including a duration criterion, a distance criterion, and a dwell time criterion. In at least one embodiment, the duration criterion includes a minimum duration criterion, where a minimum duration of travel is required for the system to include a Journey Segment in a Journey. A minimum duration of travel after engine on or a start movement can comprise a duration of time for travel, for example, from about 60 to about 90 seconds. In an exemplary embodiment, the system 10 can be configured require a vehicle travel more than 60 seconds for it to be included as a Journey Segment. For example, if an (1) engine on/ignition event or (2) an identified vehicle's first movement after a known last movement (e.g. from a previous trip or journey) or (3) a newly identified vehicle's first movement is identified for a vehicle, and the event is followed by a short duration of travel of less than 60 seconds, the system 10 is configured to exclude this Journey Segment from a Journey determination. The system 10 is configured to determine that the vehicle's short duration of movement is not a Journey start or destination.

In an embodiment, the Journey detection criterion includes a distance of travel criterion, for example 200 meters. The system 10 can be configured to exclude distances of 200 meters or less from a Journey segment. A minimum distance of travel criterion can comprise a predetermined duration of distance for travel, for example, from about 100 meters to about 300 meters. The minimum distance x (e.g. 200 meters) can be defined to an index including about 50% tolerance of the minimum distance x.

In an embodiment, a dwell time criterion can include a stop time for a vehicle. For example, a dwell time criterion can be from about 30 to about 90 seconds. A maximum dwell time can comprise a duration of stopping between an engine off/stop movement and engine on/start movement for the same vehicle, for example, from about 20 to about 120 seconds. For example, if the system 10 determines a vehicle is stopped or its engine is off for less than 30 seconds, the system can be configured not to include that stop period as the end of a Journey or in a Journey object.

As described above, in an embodiment, the system 10 is configured to process vehicle event data to determine if one or more Journey Segments comprise a Journey for a vehicle. For example, an engine on or start movement event can be followed by a distance exceeding a distance criterion (e.g. over 200 meters). Thus, the system's duration criterion does identify this segment for a Journey. However, if the car stops thereafter and continues to stay stationary for over 30 seconds, the system 10 is configured not to count that as a segment for a Journey. If the vehicle subsequently stops for less than 30 seconds and then moves again, the Dwell time criterion is met, and the system 10 is configured to include that Journey Segment in the Journey for that vehicle's travel to its final destination. Thus, the algorithm can join a plurality of Journey Segments for a Journey or a Journey object for an everyday real time drive a destination, for example, when a driver turns a car on (engine on/start movement) at home, drives for 10 miles (Distance criterion), stops at a stop light for 29 seconds, travels on to a final destination at work (engine off/stop movement). However, the system 10 is configured to ignore events that are unlikely to represent an interruption in a Journey, for example stopping at a stop light for 29 seconds (Dwell criterion) or movement less than 200 meters (Distance criterion) or less than 60 seconds (Duration criterion).

In an embodiment, the system 10 can include a plurality of criteria for each of the dwell criterion, the distance criterion, or the time criterion, for example, based on variable data. Thus, the algorithm can join a plurality of Journey Segments for a Journey for a common real time drive to a destination where additional data is known about the vehicle and the location. For example, if a vehicle is identified as a road legal electric vehicle such as an electric car, the dwell criteria can include a dwell time maximum criterion of 20 minutes at a location identified as an electric charging station. Thus, the dwell time can be extended up to between 2-20 minutes, based on, for example, other data about the location (e.g., data indicating the stop is a point of interest such as a gas station, rest area, or restaurant). The system 10 can be configured to identify a Journey when a driver of an electric car turns the car on (engine on or first movement) at home, drives for 100 miles (Distance criterion) to a charging station for charging (engine off/stop movement, 12 minutes, Dwell criterion, variable, charging station), then starts again (engine on/start movement) and travels on to a final destination at a sales meeting (engine off/stop movement). Accordingly, as will be appreciated, each of the criteria above can be configured to be variable depending on, inter alia, knowledge derived or obtained about an event vehicle data point.

In an embodiment, the system 10 is configured to identify candidate chains of Journey segments for a given device according to the criteria described above. Also, a compound Journey object can be instantiated with its start being the beginning of the chain and its end being the end of the final segment in the chain. A separate table of Journey objects can be extracted from event data and derived compound Journeys can be generated into a further table. In an embodiment, a data set including all engine on/engine off or start movement/stop movement events are identified to a unique vehicle ID. For example, each of the engine on/engine e off or start movement/stop movement events for a vehicle can be placed on a single row including the candidate Journey segments. Then, row of engine on/engine e off or start movement/stop movement events can be processed by each of the distance criterion, duration criterion, and dwell criterion to determine which Journey segments can be included or excluded from a Journey determination for a Journey object. In an embodiment, the system 10 can generate a further Journey Table, which is populated with Journey objects as determined from the events for the vehicle that meet the Journey criteria above.

In at least one embodiment, at block 514, the system 10 is configured to provide active vehicle detection by analyzing a database of vehicle event data and the summarizing of a journey of points into a Journey object with attributes, such as start time, end time, start location, end location, data point count, average interval and the like. In an embodiment, Journey objects can be put into a separate data table for processing.

In an exemplary embodiment, the system 10 can be configured to perform vehicle tracking without the need for pre-identification of the vehicle (e.g. by a VIN number). As described above, geohashing can be employed on a database of event data to geohash data to a precision of 9 characters, which corresponds to a shape sufficient to uniquely correlate the event to a vehicle. In an embodiment, the active vehicle detection comprises identifying a vehicle path from a plurality of the events over a period of time. In an embodiment, the active vehicle detection can comprise identifying the vehicle path from the plurality of events over the period of a day (24 hours). The identification comprises using, for example, a connected components algorithm. In an embodiment, the connected components algorithm is employed to identify a vehicle path in a directed graph including the day of vehicle events, in which in the graph, a node is a vehicle and a connection between nodes is the identified vehicle path. For example, a graph of journey starts and journey ends is created, where nodes represent starts and ends, and edges are journeys undertaken by a vehicle. At each edge, starts and ends are sorted temporally. Edges are created to connect ends to the next start at that node, ordered by time. Nodes are 9 digit geohashes of GPS coordinates. A connected components algorithm finds the set of nodes and edges that are connected and, a generated device ID at the start of a day is passed along the determined subgraph to uniquely identify the journeys (edges) as being undertaken by the same vehicle.

An exemplary advantage of this approach is it obviates the need for pre-identification of vehicles to event data. Journey Segments from vehicle paths meeting Journey criteria as described herein can be employed to detect Journeys and exclude non-qualifying Journey events as described above. For example, a geohash encoded to 9 digits (highest resolution) for event data showing a vehicle had a stop movement/engine e off to start movement/engine e on event within x seconds of each other (30 seconds) can be deemed the same vehicle for a Journey. For a sequence of arrives and leaves, a Journey can be calculated as the shortest path of Journey Segments through the graph.

In at least one embodiment, at block 515, the system 10 can be configured to store the event data and Journey determination data in a data warehouse 517. Data can be stored in a database format. In an embodiment, a time column can be added to the processed data. In an embodiment, the database can also comprise Point of Interest (POI) data.

The Analytics Server system 500 can include an analytics server component 516 to perform data analysis on data stored in the data warehouse 517, for example a Spark analytics cluster. The Analytics Server system 500 can be configured to perform evaluation 530, clustering 531, demographic analysis 532, and bespoke analysis 533. For example, a date column and hour column can be added to data to processed Journey data and location data stored in the warehouse 517. This can be employed for bespoke analysis 533, for example, determining how many vehicles at intersection x by date and time. The system 10 can also be configured to provide bespoke analysis 533 at the Egress Server system 400, as described with respect to FIG. 4A.

In an embodiment, a geospatial index row can be added to stored warehouse 517 data, for example, to perform hyper local targeting or speeding up ad hoc queries on geohashed data. For example, location data resolved to 4 decimals or characters can correspond to a resolution of 20 meters or under.

In an embodiment, the system 10 can be configured to process vehicle event data to provide enhanced insights and efficient processing. Exemplary processes and systems for processing event data comprise:
K nearest neighbors over an R-Tree with graph local searching and custom metrics for performing snapping of data points to roads;
DBSCAN with custom metrics for finding areas of parking related to points of interest;
XGBoost for classification of journey purpose with a classifier modified from one built over National Household Travel Survey data;
Levenshtein and Soundex for street address matching;
ARIMA for traffic volume time series forecasting;
Cross correlation and dynamic time warping for determination of road co-dependency;
Facebook Prophet for datapoint volume forecasting;
Gaussian Mixture Model for identifying traffic congestion state; and
XmR for anomaly detection control charting.

The Analytics Server system 500 can be configured to perform road snapping as described with respect to the Ingress Server system 100 hereinabove. The algorithm as described above advantageously can use individual points for snapping, and extracts as much information as possible from each data point by comparing each data point to road geometry. The vehicle data point can also be compared to statistics formed from aggregated data. In an embodiment, the snapping algorithm implemented at an ingress server to provide, inter alia, advantages in substantially real-time, low latency feeds. In an embodiment, the snapping algorithm can also be provided at the Stream Processing server system 200, Egress Server system 400, or Analytics Server system 500.

In an embodiment, the system 10 can be further configured to map the event data to a map database. The map database can be, for example, a point of interest database or other map database, including public or proprietary map databases. Exemplary map databases can include extant street map data such as Geofabric for local street maps, or World Map Database. The system 10 can be further configured to egress the data to external mapping interfaces, navigation interfaces, traffic interfaces, and connected car interfaces as described herein.

In an embodiment, a base map is given as a collection of line segments. The system 10 can be configured to include a base map given as a collection of line segments for road segment, for example employing an R-Tree index as described herein. As disclosed herein, the system 10 includes, for each line segment, geometrical information regarding the line segment's relation to its nearest neighbors. For each line segment, statistical information regarding expected traffic volumes and speeds is generated from an initial iteration of the process. Vehicle movement event data comprises longitude, latitude, heading, speed, and time-of-day. As described herein, vehicle movement event data is geohashed, for example to a 6 character geohash. Vehicle movement data enriched with the geohash can be map-matched to the base map.

In an embodiment, the system 10 can be configured to generate a lane index. Through map matching, the system 10 can be configured to analyze vehicle event data to locate each floating car data point onto a road segment. Each point has associated with it a distance it has been moved in order to make the match. As explained above, roads are represented as a single line segment in the map, so a match distance can show the presence of lanes on a road.

One exemplary advantage of the system 10 is that among large data set of vehicle movement data, the system can be configured to be highly selective and yet correct map interfaces at a high degree of resolution. For example, as of the present disclosure, the system 10 can identify and correct map data and interfaces from 10 million geohashes in the United States.

Another exemplary advantage is map interfaces and navigation systems can be improved to accurately navigate vehicles.

In an embodiment, the system can be configured to identify parking areas. As shown in FIG. 5B, at block 540 journeys are aggregated. In an embodiment, journeys can be identified as described hereinabove. Journeys can also be identified in vehicle event data streams ingressed by the Ingress Server system 100, for example as trip data identified from OEMs 14, vehicles 12, third parties 15, and the like (see FIG. 1). In embodiments, at block 545, journey points are selected for defining parking. At block 548, the system 10 is configured to cluster these points into point clusters. In an embodiment, it was found a density-based clustering algorithm, DBSCAN, though technically more difficult to implement across multiple machines, provided improved results for identifying parking areas via clustering journey vehicle event data points. Other approaches, such as K-means clustering, only targeted proximity, not density, nor were optimal for shape fitting to convex-hull or oblong shapes.

The boundaries of the point clusters are geoshaped to geographical areas. At block 550, the system 10 is configured to define a geoshape around the cluster of points. At block 552, a map-matched geoshape defines a parking area.

Once the parking area is formed, at block 554, the system 10 can be configured to track, record and analyze vehicle event parking data for historical occupancy for that parking area. Factors that can be analyzed include, for example, time of day, day of week and so on. All of this information can then be combined with current occupancy of the parking, which allows estimating the probability of empty spaces within the parking. Accordingly, outputs can include: parking location, parking boundaries, and a probability of empty space within the boundaries at a given or current time. At block 556, the analysis outputs can be outputted, for example, to third parties, downstream interfaces (e.g., for notifications as to available parking), GIS visualization tools, or stored for further processing analysis.

For example, in an embodiment, the system can be configured to identify curbside parking areas. Referring to FIG. 5C, after aggregating journeys at block 540, at block 542, the system 10 is configured to perform road snapping as described hereinabove and snap the last longitude and latitude for vehicle Journeys to a road map to form parking areas. At block 545 the system is configured to select points for curbside parking area analysis. Journey start points and Journey end points are selected for defining parking. Then, the algorithm the selects start points and end points that are nearby to a road. For example, the system 10 can be configured to select vehicle event data points that are 30-40 meters from the centerline of a road or road segment. The system 10 can be configured to filter out points for roads that are not likely to have parking. At block 546, the system 10 is configured to filter out points for roads that are not likely to have curbside parking. For example, motorways, interstate highways, service roads, and the like are excluded. At block 548, the system 10 is configured to cluster these points into curbside point clusters. In an embodiment, as noted above, it was found a density-based clustering algorithm, DBSCAN provided improved results for identifying curbsides via clustering journey vehicle event data points.

The boundaries of the curbside point clusters are geoshaped to geographical areas. At block 550, the system 10 is configured to define a convex hull around the cluster of curbside points. At block 552, the map-matched convex hull defines a curbside parking area.

Once the curbside parking area is formed, at block 554, the system 10 is configured to track, record and analyze vehicle event parking data for historical occupancy for that curbside parking area. Factors that can be analyzed include, for example, time of day, day of week and so on. All of this information can then be combined with current occupancy of the parking, which allows estimating the probability of empty spaces within the parking. Accordingly, outputs can include: parking location, parking boundaries, and a probability of empty space within the boundaries at a given or current time. At block 556, the analysis outputs can be outputted via the Egress Server system 400, for example, to third parties, downstream interfaces (e.g., for notifications as to available parking), or stored in Analytics Server system 500 for further processing analysis.

In another embodiment, the system can be configured to identify parking areas based on points of interest. As shown in FIG. 5D, at block 540 the system is configured to aggregate journeys and at block 545 the system is configured to select points for parking area analysis. For example, journey or trip end points from vehicle events are selected for defining parking areas are selected.

At block 548, the system 10 is configured to cluster these journey points into point clusters, for example, using a density-based clustering algorithm such as DBSCAN as described above. The boundaries of the endpoint point clusters are geoshaped to geographical areas. At block 550, the system 10 is configured to define a shape, for example a polygon or convex hull, around the clusters of points.

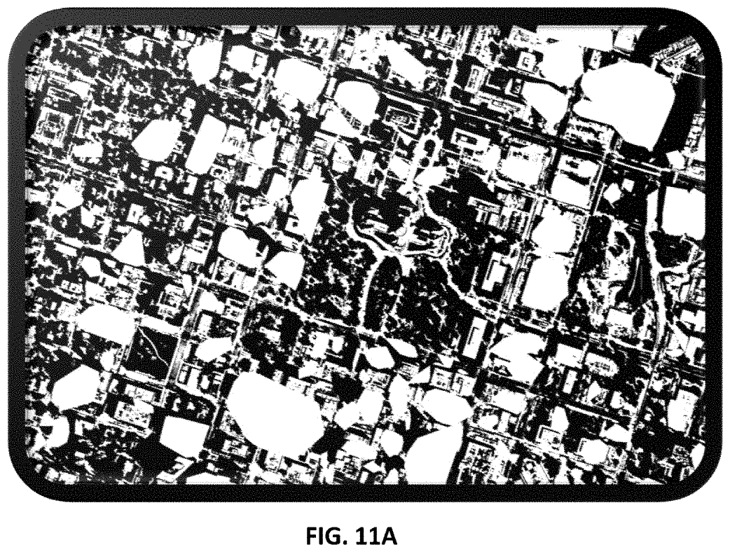

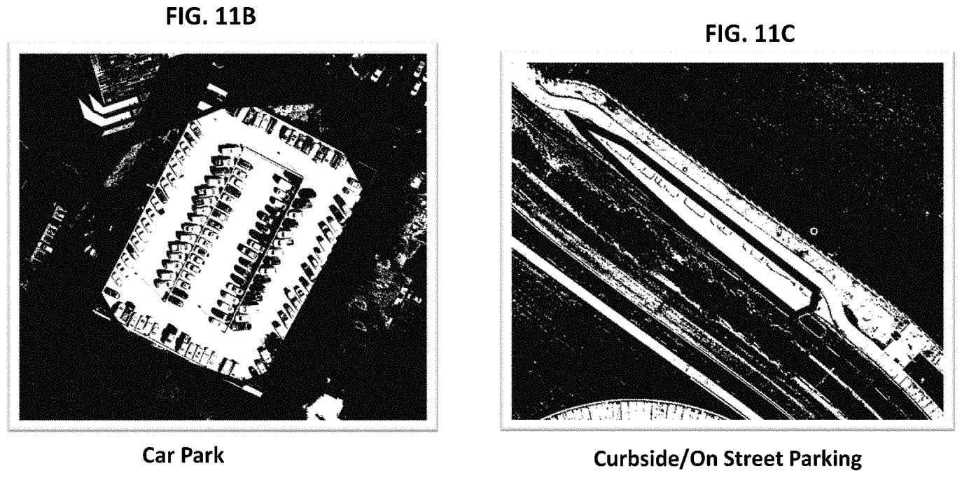

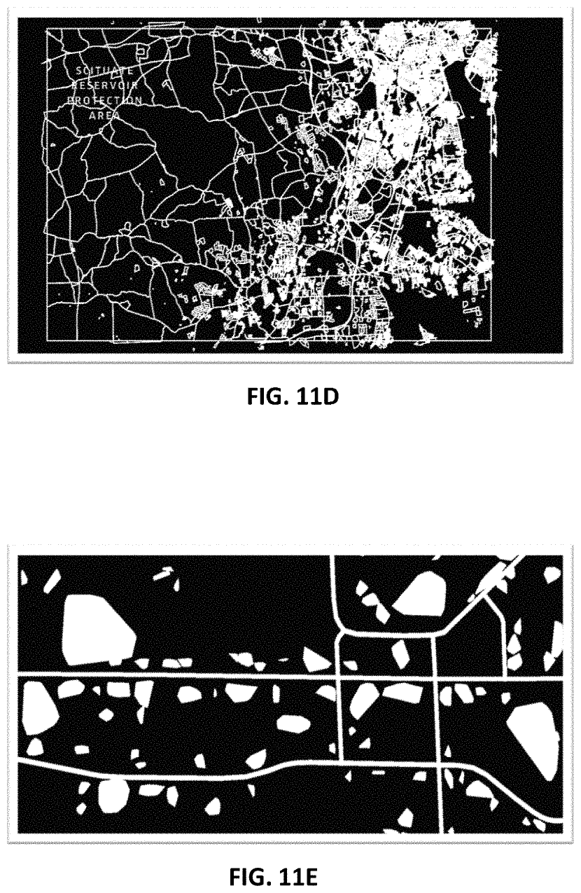

FIG. 11A shows an example a Graphic User Interface (GUI) showing of identified parking areas in downtown Austin. The car park data set covers all types of parking destinations. FIGS. 11B-11E shows examples of GUIs displaying examples of types or parking areas generated from system analysis. As noted above, boundaries can be drawn around areas with a high concentration of Journey end points. For example, parking areas can be identified as car parks (FIG. 11B) and on-street or curbside parking (FIG. 11B).

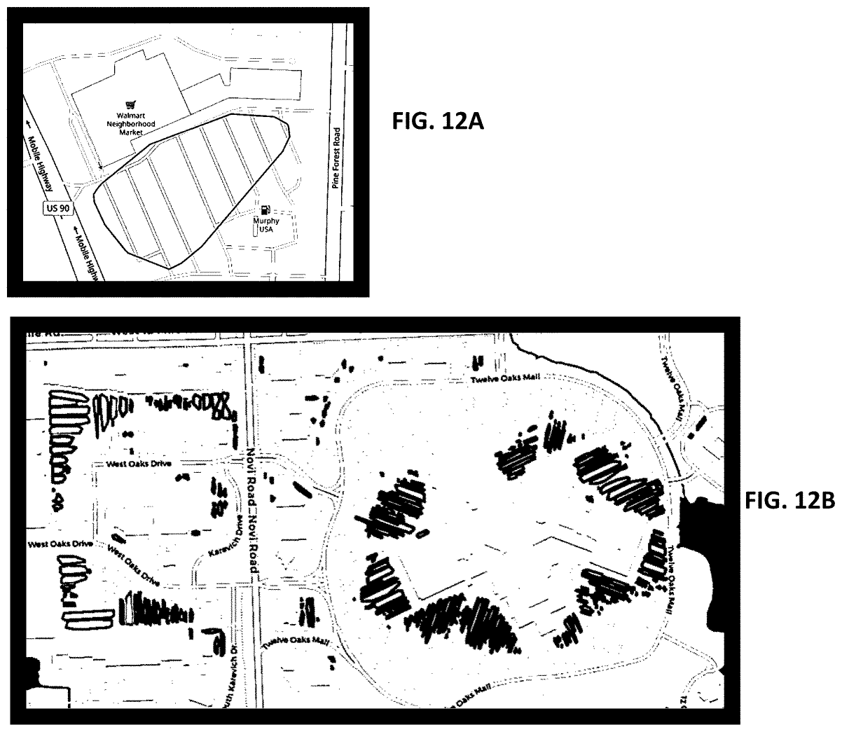

In another example, as shown in the GUIs of FIGS. 12A-12B, the system was able to identify a car park as a single shape (FIG. 12A) and then was also able to identify individual rows of parking within a car park based on clustering patterns (FIG. 12B). In an embodiment, by varying or tuning the epsilon and MinPts parameters of the DBSCAN algorithm, the system was configured to identify graduated clusters of parking. For example, by varying MinPts parameter while holding the epsilon constant at 0.01 it was found that a low MinPts value (e.g. 5) that detects all genuine parking areas also picked up unwanted noise, whereas a high MinPts value (e.g. 50) that excluded noise failed to detect some genuine parking. By varying the epsilon parameter while holding Min Pts constant, the system was able to detect either more broad or more granular parking areas. Choosing a balanced MinPts of 20, it was found, a larger epsilon (e.g. 0.010-0.020) identified large parking areas, while a smaller epsilon (e.g. 0.005) identified rows or sections of parking areas. Accordingly, the system could distinguish clusters for parking rows of a parking lot from a whole parking lot by tuning the epsilon to smaller values for smaller clusters and tuning MinPts the parameter on Journey end points.

Returning to FIG. 5D, in an embodiment, at block 547 the system is configured to obtain map data 116 and POI data 117 from database 107. For example, in an embodiment, POIs from OpenStreetMap (OSM) were ingested to database 107, with the POI data including types and categories of POS (e.g.: retail, food, office, apartment, parks and recreation, library, place of worship, townhall, post office, fire station, bank, and so on).

At block 549, the system 10 can be configured to generate an R-Tree index as described herein, with the R-Tree data including POI data. At block 551, the algorithm is configured to query the R-Tree index to identify POIs that are in close proximity to the shape. At block 552, the map-matched shapes define parking areas. For example, the system is configured to match POIs within a predetermined distance of the identified car park. The predetermined distance can be for example, a closest POI to a car park, a POI within 50-200 meters, or a combination thereof. For example, in an embodiment, the system can be configured match all POI's within 100 meters of the identified car park to the car park.

Once the parking area is formed, at block 554, the system 10 can be configured to track, record and analyze vehicle event parking data for features that further identify parking areas. Once shapes defining parking areas have been identified using DBSCAN and convex hull as described herein, further Journeys ending within those shapes can be analyzed, and data can be aggregated for the parking area as a whole, for example, by average dwell time, mean distance travelled to the parking area, and so on. This analysis can then be input to train a machine learning model described below. At block 560, the system provides, for example, a map or parking lot database with identified parking lots that are not associated with nearby POIs. At block 561, the system then provides the parking lots that are labelled to POIs to the database. At block 555, the system then enrich the databases with the updated POI data.

In an embodiment, the system can be configured to build a training database and train a machine learning algorithm to identify parking areas and predict the features associated with the parking areas. For example, one disadvantage to many map databases, both open and proprietary, is that POI data is often missing. Thus the system can be configured to predict and identify POIs associated with parking areas.

At block 560, the system provides a training database with identified parking lots that are not near POIs. At block 561, the system then provides the parking lots that are labelled POI to the training database. At block 563, the system then generates parking lot features for each individual parking lot from the Journeys that end in each lot. Features can include, for example, total visitors, number of unique visitors, average dwell time, percentage of visitors in a given time (such as day/hour).

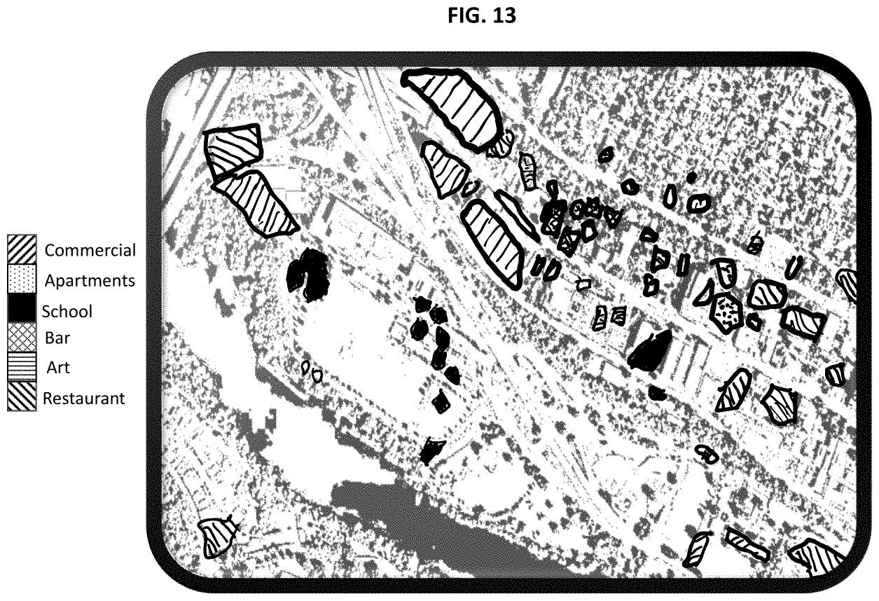

Because the system is configured to matched car parks with nearby POIs, the system can be configured to match the car park to category of POI the car park is associated with. The GUI of FIG. 13 and Table 6 shows a portion of an exemplary POI map-matched database:

TABLE 6

| | | | | number_ | points_ | | |
|---|---|---|---|---|---|---|---|
| cluster_ | | | | of_ | used_for_ | | state_ |
| unique_id | shape | geohash | geohash4 | devices | clustering | tags | cod [symbol] |
| AK_b76q_23 | POLYGON ((−165.397971 64.500193, −165.398 [symbol] | b76qum | b76q | 1 | 44 | [(″distance″: 115.646 | AK |
| AK_bds5_0 | POLYGON ((−151.53486 59.642735, −151.5352 [symbol] | bds5rc | bds5 | 253 | 1219 | [(″distance″: 0, ″tag″: [symbol] | AK |
| AK_bds5_66 | POLYGON ((−151.717525 59.708748, −151.717 [symbol] | bds5et | bds5 | 1 | 30 | null | AK |
| AK_bdtw_5 | POLYGON ((−149.438837 60.127043, −149.438 [symbol] | bdtwp3 | bdtw | 1 | 24 | [{″distance″: 163.742 | AK |
| AK_bdu2_45 | POLYGON ((−151.183097 60.494699, −151.183 [symbol] | bdu2ps | bdu2 | 1 | 26 | null | AK |
| AK_bdu3_61 | POLYGON ((−151.327748 60.652817, −151.327 [symbol] | bdu3h3 | bdu3 | 1 | 22 | null | AK |
| AK_bdu8_48 | POLYGON ((−150.912797 60.510511, −150.913 [symbol] | bdu8jz | bdu8 | 39 | 56 | [(″distance″: 3.36009 | AK |

[symbol]

indicates data missing or illegible when filed

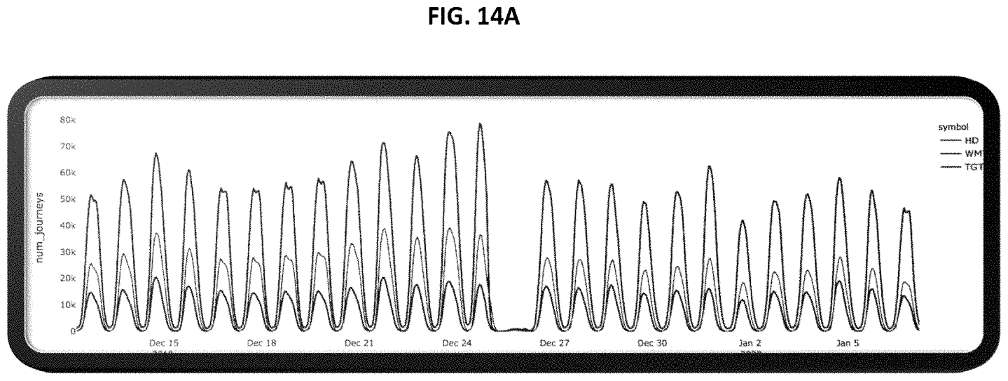

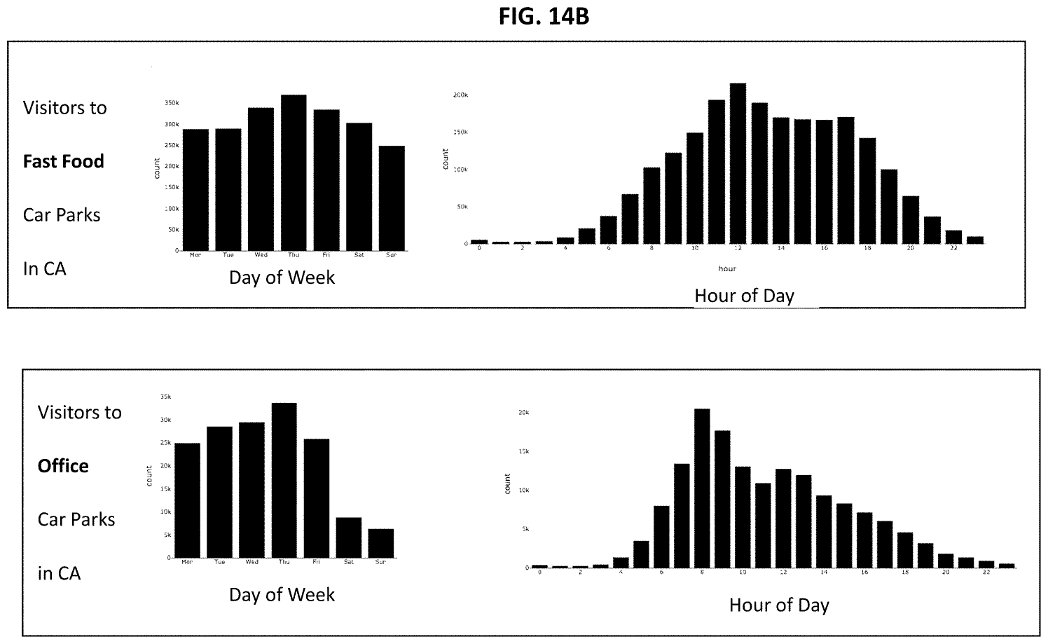

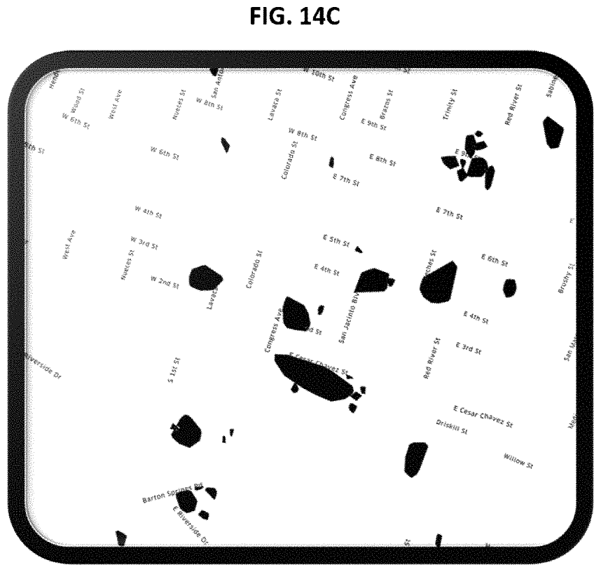

Exemplary further data and features include categories of the POIs associated with the parking areas, for example, parking areas associated with hotels, restaurants, and so on. Journeys ending in car parks can also be selected for other aggregate data, for example, Journeys ending at specific businesses over a given time period and/or location. For example, as shown in FIG. 14A the system was configured to identify Journeys ending in parking areas at specific “big box” brand stores (e.g. Target®, Wal-Mart® and Home Depot® for each day of a month in the US. In another example, the system can be configured to track and compare destination types associated with parking areas. For example, as shown in FIG. 14B, in determining work vs. leisure destinations, the system can identify unique visitors to POI categories for car parks, for example “Fast Food” or “Office” over days of the week and hours of the day in the state of California. As shown in the GUI of FIG. 14C the system can identify car parks to the closest POI category, for example, hotels.

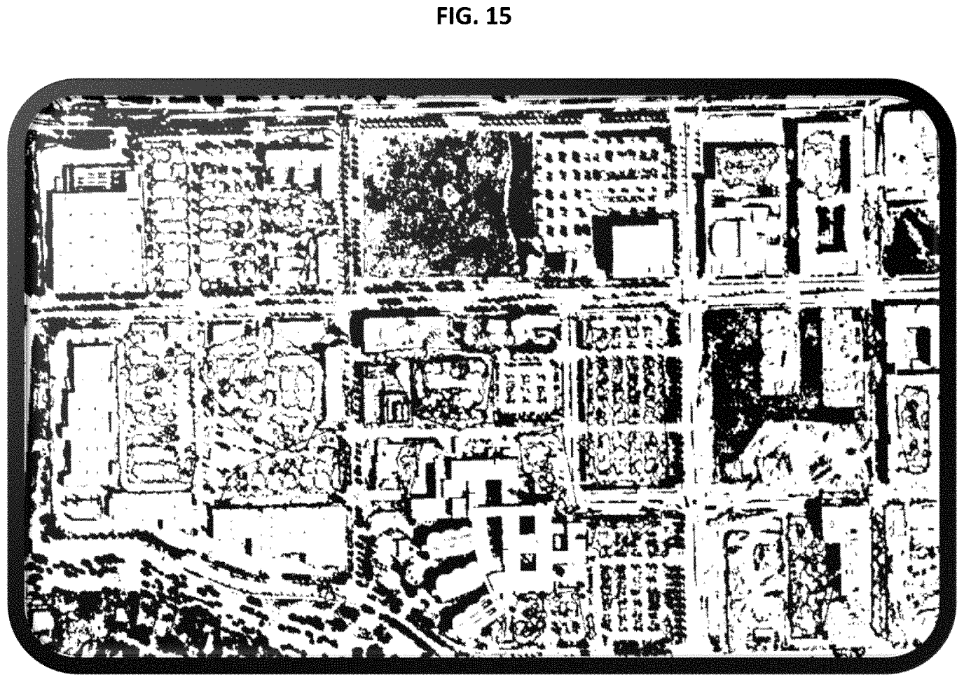

As another example, the system can be configured to identify usage patterns associated with car parks, for example, car park visits by hour, understanding where cars park within a car park, utilization of land within car parks, and areas of low parking density vs. high parking density for example, as shown in the GUI of FIG. 15.

At block 564, the system then trains a machine learning algorithm on the training database. For example, the system can employ a gradient boosting model using a positive-unlabeled algorithm to distinguish parking areas near POIs from those that are not near POIs. The machine learning algorithm can, thus trained, be employed as a prediction engine to predict which parking lots are likely to have nearby POIs present, but which are not shown on extant maps. For example, POIs can be aggregated into pre-defined categories, (e.g. shopping, entertainment, education, and so on). Different Positive-Unlabeled Gradient Boosting models are then trained on a “one versus all” basis for each category, so that each model learns to distinguish (e.g. shopping vs. not shopping, or education vs. not education). The trained models are thus configured to output a probability. For example, for a given parking area with no POIs shown on maps, the trained classifier can predict likely POI categories by identifying at which models predict a probability or confidence score of, for example, greater than 0.5, indicating the POI category is more likely than not correct.

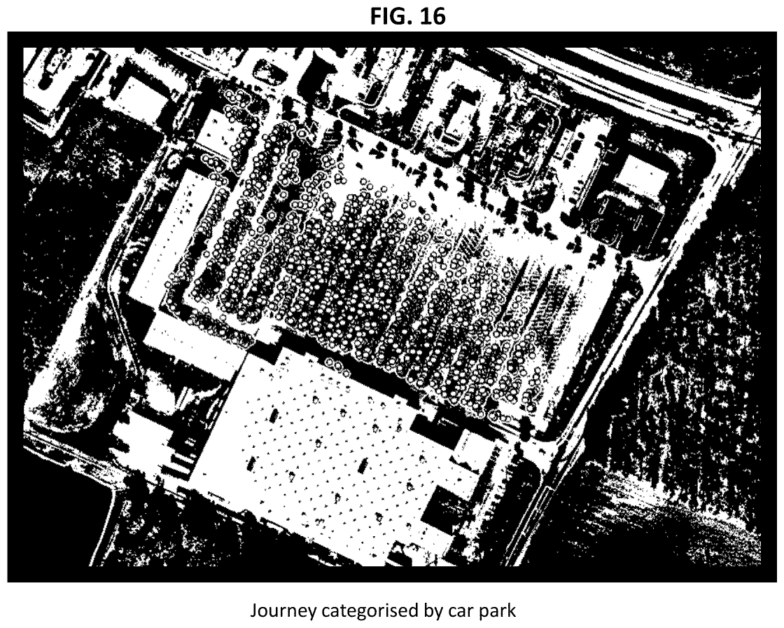

For example, in an embodiment, car parks generated in a state were used to determine journey classification. For journeys ending within or close to car parks, the top category of the park was used to determine journey reason. For Journeys ending in a car park without a tag, a prediction was made as to the main car park category. An example of Journey predictions is shown in the GUI of FIG. 16. The prediction engine was able to determine that 40% of all Journeys ended within one of the pre calculated car parks.

In one example, the system was employed to identify and generate a data set of about 3 million car parks across the United States in every state.

At block 555, the analysis outputs and predictions from the machine learning can be outputted to enrich parking lot data sets and map data to include, for example, predicted POIs for the unlabeled parking areas. At block 556, the outputs can then be outputted, for example, to third parties, downstream interfaces (e.g., for notifications as to available parking), GIS visualization tools, or stored for further processing analysis.

In another embodiment, as shown in FIGS. 5E-5F, the system can be configured to identify parking areas employing a map splitting enhancement to improve accuracy and processing efficiency. At block 536, the system 10 is configured to obtain a large map dataset, the United States for example, from database 107 and split the large map into a plurality of geohashes. Then, at block 537, the system is configured to split each of the plurality of geohashes into constituent polygons using road segments. As shown in FIG. 5E, at block 545 the system is configured to select points for parking area analysis. For example, Journey or trip end points from vehicle events are selected for each constituent road segment polygon to define parking areas. By splitting the target map into a plurality of smaller geohashes, the system can then efficiently process the separate geohashes inparallel starting at block 548, thereby expediting the processing workload and improving system latency. For example, the processing enhancement can be implemented to identify curbside parking as described above, by clustering the points for each of the separate geohashes inparallel starting at block 548 and following the process as shown in FIG. 5C inparallel for at least blocks 550-550. As shown in FIG. 5F, the system can be configured to identify parking areas based on points of interest using the map splitting enhancement to improve accuracy and processing efficiency.

FIG. 11D shows a GUI of a geohash segmented into polygons by road segments as described with reference to FIG. 5E at block 544. FIG. 11E shows example of car parks identified by running DBSCAN on all journey ends within each polygon as described with reference FIG. 5F at block 545 to block 550.

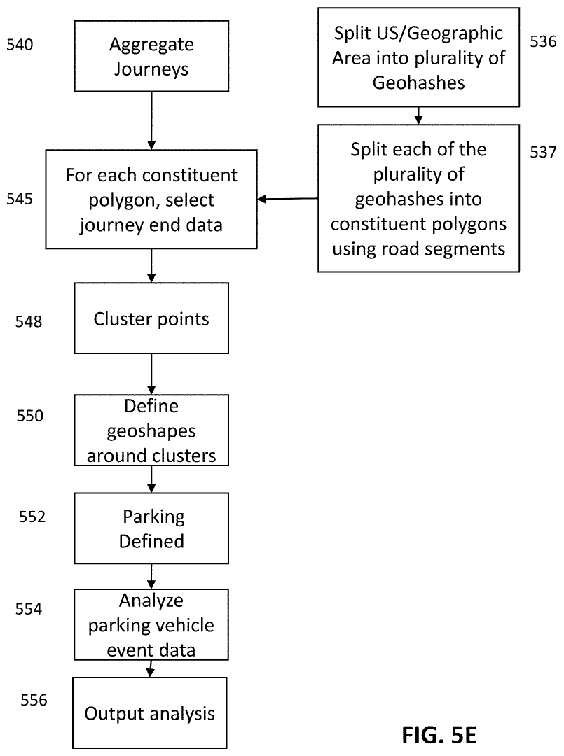

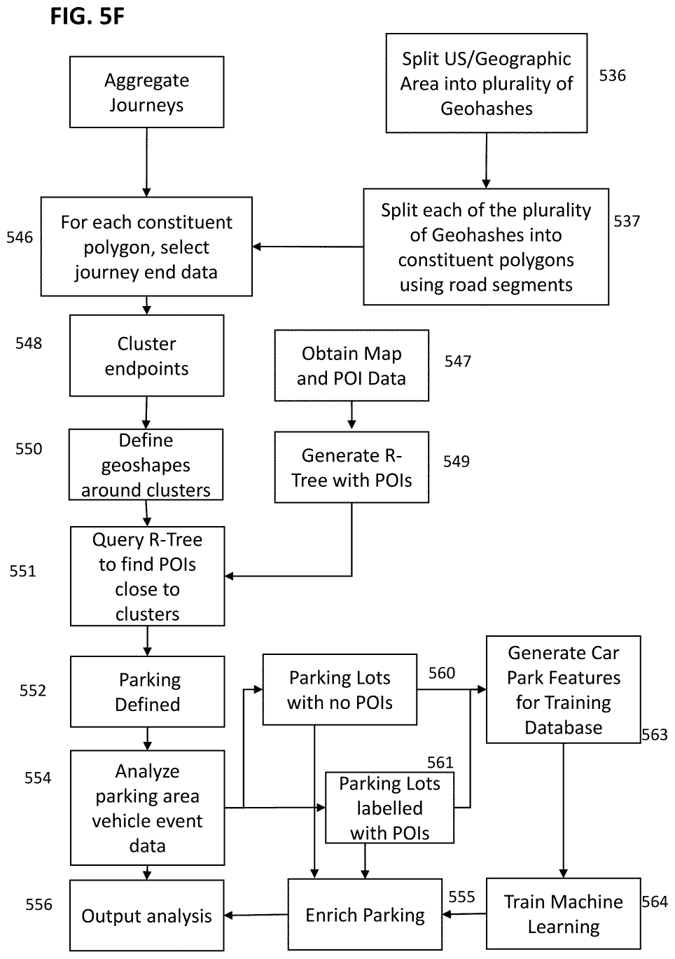

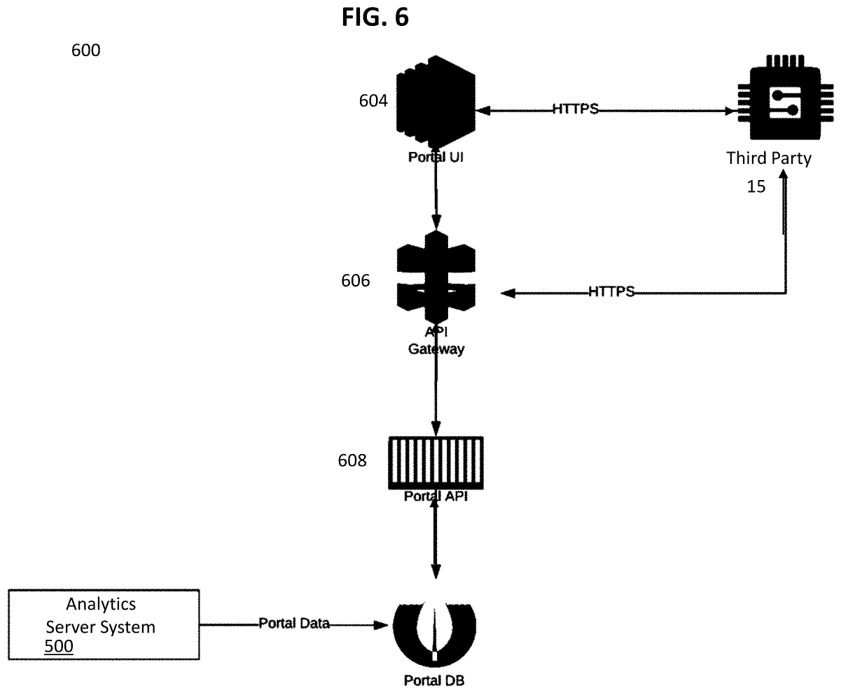

FIG. 6 is a logical architecture for a Portal Server system 600. In at least one embodiment, Portal Server system 600 can be one or more computers arranged to ingest and throughput records and event data. The Portal Server system 600 can be configured with a Portal User Interface 604 and API Gateway 606 for a Portal API 608 to interface and accept data from third party 15 users of the platform. In an embodiment, the Portal Server system 600 can be configured to provide daily static aggregates and is configured with search engine and access portals for real time access of data provided by the Analytics Server system 500. In at least one embodiment, Portal Server system 600 can be configured to provide a Dashboard to users, for example, to third party 15 client computers. In at least one embodiment, information from Analytics Server system 500 can flow to a report or interface generator provided by a Portal User interface 604. In at least one embodiment, a report or interface generator can be arranged to generate one or more reports based on the performance information. In at least one embodiment, reports can be determined and formatted based on one or more report templates.

The low latency provides a super-fast connection delivering information from vehicle source to end-user customer. Further data capture has a high capture rate of 3 seconds per data point, capturing up to, for example, 330 billion data points per month. As described herein, data is precise to lane-level with location data and 95% accurate to within a 3-meter radius, the size of a typical car.

FIG. 7 is a flow chart showing a data pipeline of data processing as described above. As shown in FIG. 7, in an embodiment, event data passes data through a seven (7) stage pipeline of data quality checks. In addition, data processes are carried out employing both stream processing and batch processing. Streaming operates on a record at a time and does not hold context of any previous records for a trip, and can be employed for checks carried out at the Attribute and record level. Batch processing can take a more complete view of the data and can encompass the full end-to-end process. Batch processing undertakes the same checks as streaming plus checks that are carried out across multiple records and Journeys.

In at least one embodiment, a dashboard display can render a display of the information produced by the other components of the system 10. In at least one embodiment, dashboard display can be presented on a client computer accessed over network. In at least one embodiment, user interfaces can be employed without departing from the spirit and/or scope of the claimed subject matter. Such user interfaces can have any number of user interface elements, which can be arranged in various ways. In some embodiments, user interfaces can be generated using web pages, mobile applications, GIS visualization tools, mapping interfaces, emails, file servers, PDF documents, text messages, or the like. In at least one embodiment, Ingress Server system 100, Stream Processing Server system 200, Egress Server system 400, Analytics Server system 500, or Portal Server system 600 can include processes and/or API's for generating user interfaces.

For example, as shown in the flow chart 800 of FIG. 8, feed data can be combined into an aggregated data set and visualized using an interface 802, for example a GIS visualization tool (e.g.: Mapbox, CARTO, ArcGIS, or Google Maps API) or other interfaces. In an embodiment, the system configured to provide connected vehicle (CV) insights and traffic products interfaces 802 therefor is described with respect to exemplary data processing of CV event data and segment event as described herein. An interface can also be configured to output data via interfaces to downstream devices such as traffic management devices, for example, via the Egress Server or Portal Sever. As shown in FIG. 8, the data feeds can include exemplary feeds such as, for example data set 804, data set 806, and connected vehicle movement data or segment event data 806.

As described herein, embodiments of the system 10, processes and algorithms can be configured to run on a web services platform host such as Amazon Web Services (AWS)® or Microsoft Azure®. A cloud computing architecture is configured for convenient, on-demand network access to a shared pool of configurable computing resources (e.g. networks, network bandwidth, servers, processing, memory, storage, applications, virtual machines, and services). A cloud computer platform can be configured to allow a platform provider to unilaterally provision computing capabilities, such as server time and network storage, as needed automatically without requiring human interaction with the service's provider. Further, cloud computing is available over a network and accessed through standard mechanisms that promote use by heterogeneous thin or thick client platforms (e.g., mobile phones, laptops, and PDAs). In a cloud computing architecture, a platform's computing resources can be pooled to serve multiple consumers, partners or other third party users using a multi-tenant model, with different physical and virtual resources dynamically assigned and reassigned according to demand A cloud computing architecture is also configured such that platform resources can be rapidly and elastically provisioned, in some cases automatically, to quickly scale out and rapidly released to quickly scale in.

Cloud computing systems can be configured with systems automatically control and optimize resource use by leveraging a metering capability at some level of abstraction appropriate to the type of service (e.g., storage, processing, bandwidth, and active user accounts). Resource usage can be monitored, controlled, and reported. As described herein, in embodiments, the system 10 is advantageously configured by the platform provider with innovative algorithms and database structures configured for low-latency.

A cloud computing architecture includes a number of service and platform configurations.

A Software as a Service (SaaS) is configured to allow a platform provider to use the provider's applications running on a cloud infrastructure. The applications are accessible from various client devices through a thin client interface such as a web browser (e.g., web-based e-mail) The consumer typically does not manage or control the underlying cloud infrastructure including network, servers, operating systems, storage, or even individual application capabilities, with the possible exception of limited user-specific application configuration settings.

A Platform as a Service (PaaS) is configured to allow a platform provider to deploy onto the cloud infrastructure consumer-created or acquired applications created using programming languages and tools supported by the provider. The consumer does not manage or control the underlying cloud infrastructure including networks, servers, operating systems, or storage, but can a have control over the deployed applications and possibly application hosting environment configurations.

An Infrastructure as a Service (IaaS) is configured to allow a platform provider to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

A cloud computing architecture can be provided as a private cloud computing architecture, a community cloud computing architecture, or a public cloud computing architecture. A cloud computing architecture can also be configured as a hybrid cloud computing architecture comprising two or more clouds platforms (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

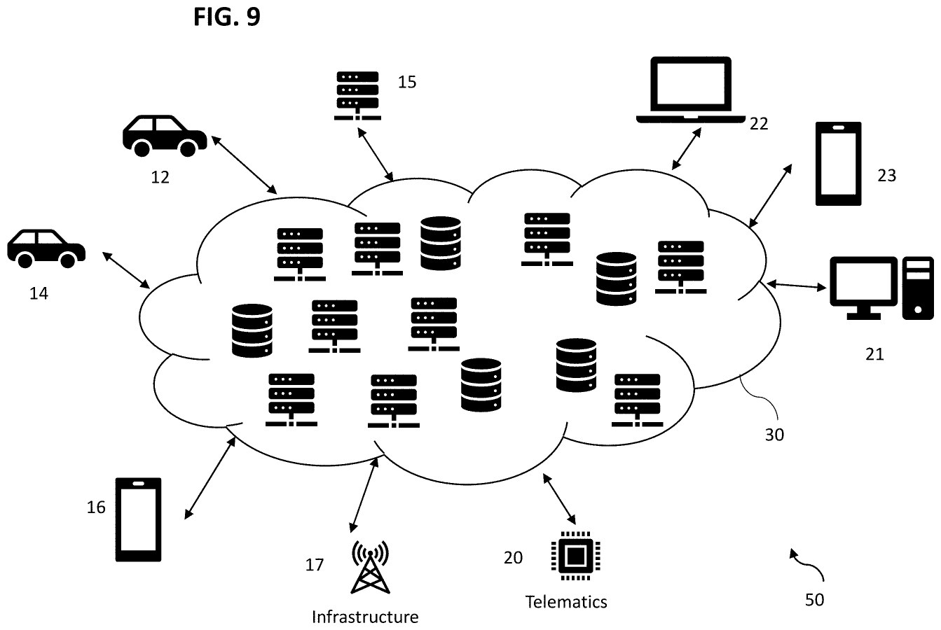

Referring now to FIG. 9, an illustrative cloud computing environment 50 is depicted. As shown, cloud computing environment 50 comprises one or more cloud computing nodes 30 with which local computing devices used by cloud consumers, such as, for example, personal digital assistant (PDA) or cellular telephone 23, desktop computer 21, laptop computer 22, and event such as OEM vehicle sensor data source 14, application data source 16, telematics data source 20, wireless infrastructure data source 17, and third party data source 15 and/or automobile computer systems such as vehicle data source 12. Nodes 30 can communicate with one another. They can be grouped (not shown) physically or virtually, in one or more networks, such as private, community, public, or hybrid clouds as described herein, or a combination thereof. The cloud computing environment 50 is configured to offer infrastructure, platforms and/or software as services for which a cloud consumer does not need to maintain resources on a local computing device. It is understood that the types of computing devices shown in FIG. 9 are intended to be illustrative only and that computing nodes 30 and cloud computing environment 50 can communicate with any type of computerized device over any type of network and/or network addressable connection (e.g., using a web browser).

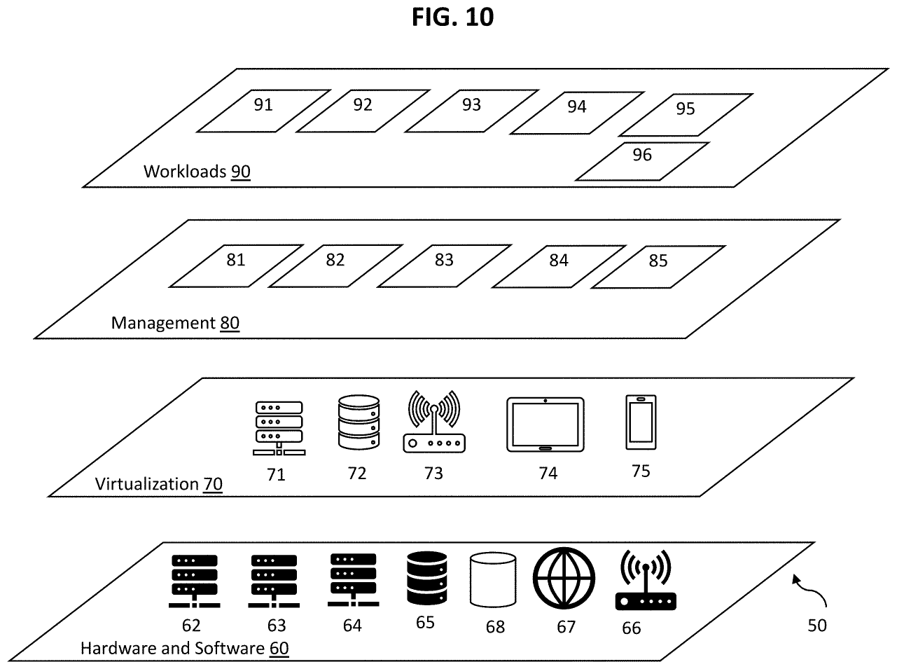

Referring now to FIG. 10, a set of functional abstraction layers provided by cloud computing environment 50 (FIG. 9) is shown. The components, layers, and functions shown in FIG. 10 are illustrative, and embodiments as described herein are not limited thereto. As depicted, the following layers and corresponding functions are provided:

A hardware and software layer 60 can comprise hardware and software components. Examples of hardware components include, for example: mainframes 61; servers 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one example, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management so that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment can be utilized. Examples of workloads and functions that can be provided from this layer include mapping and navigation 91; ingress processing 92, stream processing 93; portal dashboard delivery 94 same number; data analytics processing 95; and egress and data delivery 96.

Although this disclosure describes embodiments on a cloud computing platform, implementation of embodiments as described herein are not limited to a cloud computing environment.

Embodiments described with respect to systems 10, 50, 100, 200, 400, 500, 600 and 700 described in conjunction with FIGS. 1-10, can be implemented by and/or executed on a single network computer. In other embodiments, these processes or portions of these processes can be implemented by and/or executed on a plurality of network computers. Likewise, in at least one embodiment, processes described with respect to systems 10, 50, 100, 200, 400, 500 and 600, or portions thereof, can be operative on one or more various combinations of network computers, client computers, virtual machines, or the like can be utilized. Further, in at least one embodiment, the processes described in conjunction with FIGS. 1-10 can be operative in system with logical architectures such as those also described in conjunction with FIGS. 1-10.

It will be understood that each block of the flowchart illustration, and combinations of blocks in the flowchart illustration, can be implemented by computer program instructions. These program instructions can be provided to a processor to produce a machine, such that the instructions, which execute on the processor, create means for implementing the actions specified in the flowchart block or blocks. The computer program instructions can be executed by a processor to cause a series of operational steps to be performed by the processor to produce a computer-implemented process such that the instructions, which execute on the processor to provide steps for implementing the actions specified in the flowchart block or blocks. The computer program instructions can also cause at least some of the operational steps shown in the blocks of the flowchart to be performed in parallel. Moreover, some of the steps can also be performed across more than one processor, such as might arise in a multi-processor computer system or even a group of multiple computer systems. In addition, one or more blocks or combinations of blocks in the flowchart illustration can also be performed concurrently with other blocks or combinations of blocks, or even in a different sequence than illustrated without departing from the scope or spirit of the disclosure.

Accordingly, blocks of the flowchart illustration support combinations for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments.

1. A system comprising: a memory including program instructions and a processor configured to execute instructions to at least:
ingest vehicle event data; and
process the vehicle event data at the server to identify a parking area, wherein the processing comprises:
identifying a plurality of Journeys from vehicle event data;
matching the selected points to map data from a map database;
selecting Journey points from the plurality Journeys;
clustering the selected points with a clustering algorithm; and
defining a shape around the cluster of points to define a parking area.

2. The system of claim 1, wherein the clustering algorithm is a density-based algorithm.

3. The system of claim 2, wherein the density-based algorithm includes a DBSCAN algorithm.

4. The system of claim 2, wherein the processor is configured to execute instructions to at least:
road snap the longitude and latitude of each of the Journey points to the map database;
select Journey start points and Journey end points as the Journey points;
cluster the road-snapped Journey points to define a cluster of curbside points;
define a convex-hull shape around the clustered points to define the parking area as a curbside parking area.

5. The system of claim 1, wherein the processor is configured to execute instructions to at least:
identify map areas unlikely to be the curbside parking areas; and
filter out Journey points mapped to the areas unlikely to be the curbside parking areas.

6. The system of claim 1, wherein the processor is configured to execute instructions to at least:
select the Journey end points as the Journey points;
access map data comprising Point of Interest (POI) data
generate an R-Tree Index with the POI data;
query the R-Tree to identify POIs in a defined close proximity to the clustered Journey points; and
define a parking area based on the shapes defined around the clustered data points close to the POIs; and
label the parking lot areas with the POIs.

7. The system of claim 6, wherein the defined close proximity is from 50 meters to 200 meters.

8. The system of claim 6, wherein the processor is configured to execute instructions to at least: enrich a map database having identified parking lot areas that are not associated with POIs with the labeled parking lot areas.

9. The system of claim 6, wherein the processor is configured to execute instructions to at least:
analyze the vehicle event data of Journeys with the Journey end points of the identified parking areas.

10. The system of claim 6, wherein the processor is configured to execute instructions to at least:
provide a training database with the parking lots that are labelled with POI;
provide the training database with identified parking lots that are not labelled with POI;
generate parking lot features from vehicle event data for the Journeys with Journey end points of the identified parking areas;
train a prediction engine on the training database.

11. The system of claim 10, wherein the features include one or more of a total visitors number, a number of unique visitors, an average dwell time, and a percentage of visitors in a defined time period.

12. The system of claim 10, wherein the prediction engine comprises a plurality of Positive-Unlabeled Gradient Boosting models configured to output a probability score for a POI category.

13. The system of claim 1, wherein the system comprises a plurality of processors and the system is configured to process the location event data for a map data set inparallel to identify a parking area, wherein the parallel processing comprises:
obtaining the map data set;
splitting the map data set into a plurality of geohashes;
splitting each of the plurality of geohashes into road segment polygons, and
selecting the Journey points for each road segment polygon and processing each road segment polygon in parallel to at least, for each road segment polygon:
cluster the selected points with a clustering algorithm; and
define a shape around the cluster of points to define a parking area.

14. The system of claim 13, wherein at least one of the processors is configured execute instructions to at least
road snap the longitude and latitude of each of the Journey points to the map database, and
select Journey start points and Journey end points as the Journey points;
and the plurality of processors are configured to execute instructions to parallel process each road segment polygon to at least:
cluster the road-snapped Journey points to define a cluster of curbside points; and
define a convex-hull shape around the clustered points to define the parking area as a curbside parking area.

15. The system of claim 13, wherein at least one of the processors are configured to select the Journey end points as the Journey points; and, after parallel processing each road segment polygon, execute instructions to at least:
access map data comprising Point of Interest (POI) data
generate an R-Tree Index with the POI data;
query the R-Tree to identify POIs in a defined close proximity to the clustered Journey points; and
define a parking area based on the shapes defined around the clustered data points close to the POIs; and
label the parking lot areas with the POIs.
